(19) United States
(12) Patent Application Publication
(10) Pub. No.: US 2026/0056506 A1
(43) Pub. Date: Feb. 26, 2026

(54) CARTRIDGE

(71) Applicant: CANON KABUSHIKI KAISHA, Tokyo (JP)

(72) Inventors: YUKIO KUBO, Tokyo (JP); YU FUKASAWA, Tokyo (JP); NORITOMO YAMAGUCHI, Kanagawa (JP); AKINORI MITSUMATA, Tokyo (JP)

(21) Appl. No.: 19/307,308

(22) Filed: Aug. 22, 2025

(30) Foreign Application Priority Data
Aug. 23, 2024 (JP) 2024-143445

(51) Int. Cl. G03G 21/16; G03G 15/08; G03G 21/20

(52) U.S. Cl. CPC G03G 21/1647; G03G 15/0863; G03G 15/0875; G03G 15/0877; G03G 21/206; G03G 2215/068; G03G 2215/0697; G03G 2221/163

(57) ABSTRACT

A cartridge includes a first chamber provided with a discharge opening; a filter; a second chamber provided with an inlet for taking in the air from an outside of the cartridge; a pipe provided in the first chamber and for permitting passing of the toner, wherein the pipe is provided with a first pipe opening and a second pipe opening for communicating with the discharge opening, the pipe being extended from the first pipe opening to the second pipe opening; and a memory. In a case where a direction in which the first chamber and the second chamber are arranged is a gravitational direction and the cartridge is directed in a predetermined direction in which at least a part of the first chamber is positioned above the second chamber, the memory is provided on an upper surface or a lower surface of the cartridge.

### BACKGROUND

### Field of the Technology

The present disclosure relates to a cartridge for accommodating toner.

### Description of the Related Art

In general, an image forming apparatus of an electrophotographic type forms an image by transferring a toner image, formed on a surface of a photosensitive drum, onto a transfer material as a transfer medium. Further, as a supply type of a developer, for example, a process cartridge type and a toner supply type are known. The process cartridge type is a type such that the photosensitive drum and a developing container are integrally assembled into a process cartridge and when the developer is used up, the process cartridge is exchanged with a new article.

On the other hand, the toner supply type is a type such that when toner is used up, new toner is supplied to the developing container. Conventionally, an image forming apparatus in which the toner is supplied by using a toner pack detachably mountable to the developing container (see Japanese Laid-Open Patent Application No. 2020-154300).

### SUMMARY

According to an aspect of the present disclosure, there is provided a cartridge comprising: a first chamber configured to accommodate toner and provided with a discharge opening for permitting discharge of the toner, accommodated in the first chamber, to an outside of the cartridge; a filter configured to prevent passing of the toner and to permit passing of air; a second chamber adjacent to the first chamber through the filter and provided with an inlet for taking in the air from the outside of the cartridge; a pipe provided in the first chamber and configured to permit passing of the toner, wherein the pipe is provided with a first pipe opening which opposes a part of the filter and which opens toward the part and with a second pipe opening configured to communicate with the discharge opening, the pipe being extended from the first pipe opening to the second pipe opening; and a memory configured to store information and including a memory contact, wherein in a case where a direction in which the first chamber and the second chamber are arranged is a gravitational direction and the cartridge is directed in a predetermined direction in which at least a part of the first chamber is positioned above the second chamber, the memory is provided on an upper surface or a lower surface of the cartridge.

Features of the present disclosure will become apparent from the following description of embodiments with reference to the attached drawings. The following description of embodiments are described by way of example.

### BRIEF DESCRIPTION OF THE DRAWINGS

FIG. 1 is an entire schematic view showing an image forming apparatus according to a first embodiment.

Part (a) of FIG. 2 is a perspective view showing the image forming apparatus, part (b) of FIG. 2 is a perspective view showing the image forming apparatus in a state in which a front door is open, and part (c) of FIG. 2 is a perspective view showing the image forming apparatus in a state in which a toner cartridge is demounted from the toner cartridge.

FIG. 3 is a perspective view showing an image forming unit.

Part (a) of FIG. 4 is a perspective view showing the image forming unit in a state in which the toner cartridge is demounted, and part (b) of FIG. 4 is an enlarged perspective view showing a cartridge holder in the state in which the toner cartridge is demounted.

Part (a) of FIG. 5 is a top (plan) view showing a laser scanner and an image forming unit, and part (b) of FIG. 5 is a top view showing the image forming unit.

Part (a) of FIG. 6 is a sectional view showing a 6A-6A cross section of part (b) of FIG. 5, and part (b) of FIG. 6 is a sectional view showing a 6B-6B cross section of part (b) of FIG. 5.

FIG. 7 is a perspective view showing a state in which the image forming unit is pulled out from an apparatus main assembly.

Part (a) of FIG. 8 is a front view showing the toner cartridge, part (b) of FIG. 8 is a top view showing the toner cartridge, part (c) of FIG. 8 is a bottom view showing the toner cartridge, part (d) of FIG. 8 is a side view showing the toner cartridge, and part (e) of FIG. 8 is a rear view showing the toner cartridge.

Part (a) of FIG. 9 is a schematic view showing a 9A-9A cross section of part (e) of FIG. 8, part (b) of FIG. 9 is a perspective view showing a discharge pipe out along XZ plane, and part (c) of FIG. 9 is an exploded perspective view.

Part (a) of FIG. 10 is a sectional view showing a 10A-10A cross section of part (b) of FIG. 8, and part (b) of FIG. 10 is a perspective view showing the toner cartridge cut along YZ plane.

FIG. 11 is a perspective view showing a memory tag.

FIG. 12 is a front view showing the toner cartridge mounted in the cartridge holder.

FIG. 13 is a sectional view showing a 13A-13A cross section of FIG. 12.

Part (a) of FIG. 4 is a front view showing a toner cartridge in an embodiment 2, part (b) of FIG. 14 is a top view showing the toner cartridge, part (c) of FIG. 14 is a bottom view of the toner cartridge, part (d) of FIG. 14 is a side view showing the toner cartridge, and part (e) of FIG. 14 is a rear view showing the toner cartridge.

FIG. 15 is a front view showing the toner cartridge mounted in a cartridge holder.

FIG. 16 is a sectional view showing a 16A-16A cross section of FIG. 15.

FIG. 17 is a sectional view showing a toner cartridge and a memory tag in a third embodiment.

### DESCRIPTION OF THE EMBODIMENTS

### First Embodiment

### [General Constitution]

First, a first embodiment of the present disclosure while described. An image forming apparatus 1 according to the first embodiment is a laser beam printer of an electrophotographic type. Incidentally, the image forming apparatus refers to an apparatus which includes a printer, a copying machine, a facsimile machine, and a multi-function machine and which form an image on a sheet used as a recording medium on the basis of image information inputted from an external PC or image information read from an original. Further, the image forming apparatus may include the case where an option feeder, an image reading apparatus, a sheet passing apparatus, or the like is connected to an apparatus main assembly having an image forming function, but such an entire system in which the optional apparatuses (devices) are connected to the apparatus main assembly is also a type of the image forming apparatus.

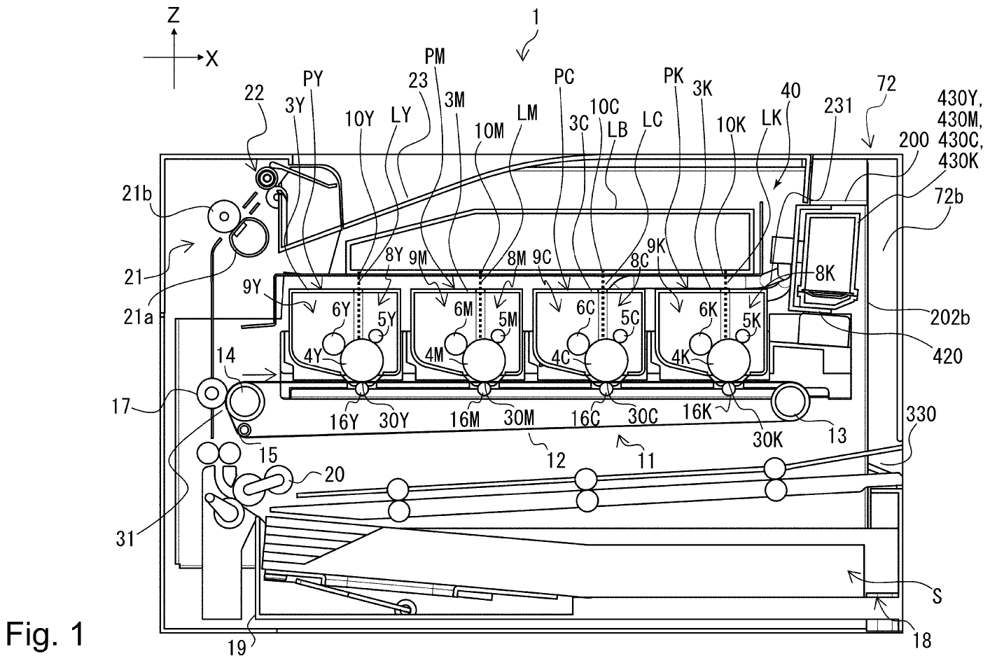

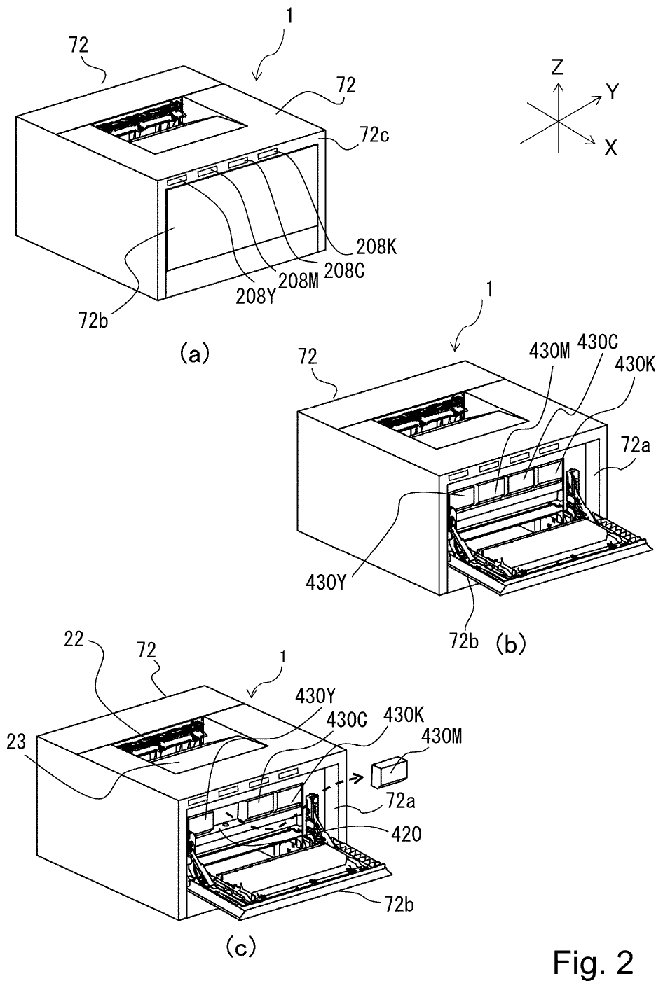

The image forming apparatus 1 includes, as shown in FIG. 1, an image in forming portion 40 for forming the image on a sheet S, a feeding unit 18, a fixing unit 21, and a discharging roller pair 22. The image forming portion 40 is provided with four process cartridges PY, PM, PC, and PK for yellow (Y), magenta (M), cyan (C), and black (K), respectively, and a laser scanner LB. The laser scanner LB is disposed above the process cartridges PY, PM, PC, and PK. Incidentally, instead of the laser scanner LB, an LED exposure unit may be applied.

Incidentally, a portion obtained by removing the process cartridges PY, PM, PC, and PK, and toner cartridges 430Y, 430M, 430C, and 430K which are described later from the image forming apparatus 1 is referred to as a main assembly or an apparatus main assembly 72 of the image forming apparatus 1 in some cases. Incidentally, in the following description, the toner cartridges 430Y, 430M, 430C, and 430K are referred simply to as cartridges 430Y, 430M, 430C, and 430K, respectively, in some instances. The process cartridges PY, PM, PC, and PK may be supported so as to be detachably mountable to the apparatus main assembly 72 or may be fixed so as not to be detachably mountable to the apparatus main assembly 72.

In this embodiment, to reference numerals or symbols of component parts corresponding to yellow toner, magenta toner, cyan toner, and black toner, suffixes P, Y, M, C, and K are added. Constitutions and operations of the component parts to which these suffixes are added and substantially the same except for the colors of the toner. Accordingly, in the following, in the case where particular distribution is not needed, the component parts are collectively described by omitting the suffixes Y to K described above.

Further, in the following description, unless otherwise specified, on the premise that the process cartridges PY, PM, PC, and PK and the toner cartridges 430Y, 430M, 430C, and 430K take a normal attitude, i.e., an attitude in which these cartridges are mounted to the apparatus main assembly 72, directions (X, Y, Z) are defined as follows.

As shown in part (a) of FIG. 2, a front-rear direction is represented by X axis, and a direction directed from a rear surface toward a front surface is defined as X direction. The X direction is also referred to as a front direction or a frontward direction in some cases. Further, with respect to the X direction of the image forming apparatus 1, a downstream side and an upstream side are also referred to as a front surface side and a rear surface side, respectively, in some cases.

A left-right direction is represented by Y axis, and a direction directed from left toward right is defined as Y direction. The Y direction is also referred to as a right (ward) direction in some cases. Further, with respect to the Y direction, a downstream side and an upstream side are also referred to as a right side and a left side, respectively, in some cases.

An up-down direction is represented by Z axis, and a direction directed from below toward above is defined as Z direction.

The Z direction is also referred to as an upward direction, a height direction, or a vertical direction in some cases. Further, with respect to the Z direction of the image forming apparatus 1, a downstream side is also referred to as an upper side, in some cases, an upper surface side, and a top surface side, and an upstream side is also referred to as a lower side, a lower surface side, and a bottom side.

The X axis, the Y axis, and the Z axis are in a relationship in which these axes are perpendicular to each other. For example, the Z axis is perpendicular to the Y axis, and is also perpendicular to the Z direction. Further, a flat plane perpendicular to the X axis is referred to as a YZ flat plane, a flat plane perpendicular to the Y axis is referred to as a ZX flat plane, and a flat plane perpendicular to the Z axis is referred to as an XZ flat plane in some instances. For example, the XY flat plane is a horizontal plane. The X direction and the Y direction are directions along the XY flat plane which is the horizontal plane.

The process cartridge PY includes a drum unit 8Y and a developing unit 9Y. The drum unit 8Y includes a photosensitive drum 4Y and a charging roller 5Y. The photosensitive drum 4Y is constituted by applying an organic photoconductive layer on an outer peripheral surface of an aluminum cylinder and is rotated by an unshown driving motor. Incidentally, instead of the photosensitive drum 4Y, a photosensitive belt may also be used. The developing unit 9Y includes a developing container 3Y for accommodating yellow toner and a developing roller 6Y for developing an electrostatic latent image on the photosensitive drum 4Y.

Similarly, the process cartridge PM includes a drum unit 8M and a developing unit 9M. The drum unit 8M includes a photosensitive drum 4M and a charging roller 5M. The photosensitive drum 4M is constituted by applying an organic photoconductive layer on an outer peripheral surface of an aluminum cylinder and is rotated by an unshown driving motor. Incidentally, instead of the photosensitive drum 4M, a photosensitive belt may also be used. The developing unit 9M includes a developing container 3M for accommodating magenta toner and a developing roller 6M for developing an electrostatic latent image on the photosensitive drum 4M.

Further, the process cartridge PC includes a drum unit 8C and a developing unit 9C. The drum unit 8C includes a photosensitive drum 4C and a charging roller 5C. The photosensitive drum 4C is constituted by applying an organic photoconductive layer on an outer peripheral surface of an aluminum cylinder and is rotated by an unshown driving motor. Incidentally, instead of the photosensitive drum 4C, a photosensitive belt may also be used. The developing unit 9C includes a developing container 3C for accommodating cyan toner and a developing roller 6C for developing an electrostatic latent image on the photosensitive drum 4C.

Further, the process cartridge PK includes a drum unit 8K and a developing unit 9K. The drum unit 8K includes a photosensitive drum 4K and a charging roller 5K. The photosensitive drum 4K is constituted by applying an organic photoconductive layer on an outer peripheral surface of an aluminum cylinder and is rotated by an unshown driving motor. Incidentally, instead of the photosensitive drum 4K, a photosensitive belt may also be used. The developing unit 9K includes a developing container 3K for accommodating black toner and a developing roller 6K for developing an electrostatic latent image on the photosensitive drum 4K.

These four process cartridges PY, PM, PC, and PK are arranged and disposed in the X direction. Further, the image forming portion 40 is provided with an intermediary transfer belt unit 11 disposed below the process cartridges PY, PM, PC, and PK. The intermediary transfer belt unit 11 includes an intermediary transfer belt 12 wound around a driving roller 14, a tension roller 13, and an assisting roller 15 and includes a secondary transfer roller 17, and the intermediary transfer belt 12 is rotated clockwise in FIG. 1 by the driving roller 14. Inside the intermediary transfer belt 12, primary transfer rollers 16Y, 16M, 16C, and 16K are provided.

The primary transfer rollers 16Y, 16K, 16C, and 16K contact the photosensitive drums 4Y, 4M, 4C, and 4K, respectively, and form primary transfer portions 30Y, 30M, 30C, and 30K, respectively. The secondary transfer roller 17 is disposed opposed to the driving roller 14. The secondary transfer roller 17 and the intermediary transfer belt 12 are in contact with each other and form a secondary transfer portion 31.

The fixing unit 21 includes a fixing film 21a and a pressing roller 21b press-contacted to the fixing film 21a. The feeding unit 18 is provided in a lower portion of the image forming apparatus 1. The feeding unit 18 is provided with a feeding cassette 19 pullable from and mountable into the apparatus main assembly 72, and a feeding roller 20 for feeding the sheet S accommodated in the feeding cassette 19. Further, the feeding unit 18 is provided with a manual feeding port 330 into which a sheet is manually inserted. Incidentally, the sheet includes paper such as a sheet and an envelope, a plastic film such as an overhead projection (OHP) sheet, a cloth, and the like.

[Image forming operation]

Next, an image forming operation of the thus-constituted image forming apparatus 1 will be described. When an image signal is inputted from an unshown personal computer to the laser scanner LB. The photosensitive drums 4Y, 4M, 4C, and 4K are irradiated with laser light LY, LM, LC, and LK, respectively, each corresponding to the image signal and emitted from the laser scanner LB.

At this time, the photosensitive drum 4Y is electrically charged uniformly to a predetermined polarity and a predetermined potential in advance by the charging roller 5Y, and then is irradiated with the laser light LY from the laser scanner LB, so that the electrostatic latent image is formed on a surface of the photosensitive drum 4Y. The electrostatic latent image formed on the photosensitive drum 4Y is developed by the developing roller 6Y, so that a toner image of yellow (Y) is formed on the photosensitive drum 4Y.

Similarly, on the photosensitive drums 4M, 4C, and 4K, toner images of magenta (M), cyan (C), and black (K) are also formed, respectively. The toner images formed on the photosensitive drums are transferred onto the intermediary transfer belt 12 by the primary transfer rollers 16Y, 16, 16C, and 16K and then are conveyed to the secondary transfer roller 17 by the intermediary transfer belt 12 rotated by the driving roller 14.

Incidentally, an image forming process for each color is performed at a timing when the toner image is superposed on the upstream toner image primarily transferred onto the intermediary transfer belt 12. The toner remaining on the surface of each photosensitive drum after the respective color toner images are transferred onto the intermediary transfer belt 12 is removed by an unshown cleaning device.

In parallel to this image forming process, the sheet S accommodated in the feeding cassette 19 of the feeding unit 18 or the sheet supplied through the manual feeding port 330 is conveyed toward the secondary transfer portion 31. In the secondary transfer portion 31, onto the sheet S, a full-color toner image on the intermediary transfer belt 12 is transferred by a secondary transfer bias applied to the secondary transfer roller 17. To the sheet S on which the toner image, predetermined heat, and predetermined pressure are imparted by the fixing film 21a and the pressing roller 21b and the pressing roller 21b of the fixing unit 21, so that the toner is melted and stuck (fixed). The sheet S passed through the fixing unit 21 is discharged in a direction along the X direction by the discharging roller pair 22 and is stacked on a discharge tray 23 provided at an upper portion of the apparatus main assembly 72.

### [Schematic Constitution of Toner Cartridge]

Next, by using parts (a) to (c) of FIG. 2, a schematic constitution of the toner cartridges 430Y, 430M, 430C, and 430K will be described. Part (a) of FIG. 2 is a perspective view showing the image forming apparatus 1, part (b) of FIG. 2 is a perspective view showing the image forming apparatus 1 in a state in which a front door 72b is open, and part (c) of FIG. 2 is a perspective view showing the image forming apparatus 1 in a state in which the toner cartridge 430M is demounted.

As shown in part (a) of FIG. 2, the image forming apparatus 1 includes the front door 72b openably and closably supported by a casing of the apparatus main assembly 72. The front door 72b covers, as shown in parts (a) and (b) of FIG. 2, a front portion of the apparatus main assembly 72, i.e., an opening 72a provided in a downstream end portion with respect to the X direction by being positioned in a closed position. Further, the front door 72b opens the opening 72a of the apparatus main assembly 72 by being positioned in an open position as shown in part (b) of FIG. 2. The front door 72b is capable of maintaining an attitude thereof in the open position.

As shown in part (b) of FIG. 2, when the front door 72b is opened from the closed position to the open position, the toner cartridges 430Y, 430M, 430C, and 430K are exposed to an outside of the image forming apparatus 1 through the opening 72a. For this reason, a user is capable of accessing the toner cartridges 430Y, 430M, 430C, and 430K. The toner cartridges 430Y, 430M, 430C, and 430K are capable of supplying toner to the developing containers 3Y, 3M, 3C, and 3K of the process cartridges PY, PM, PC, and PK, respectively.

The toner cartridges 430Y, 430M, 430C, and 430K are disposed on a downstream side in the X direction and on a downstream side in the Z direction of the apparatus main assembly 72, i.e., on a front surface side and an upper side of the apparatus main assembly 72. In other words, the toner cartridges 430Y, 430M, 430C, and 430K are disposed on the downstream side of the apparatus main assembly 72 with respect to a sheet discharging direction of the discharging roller pair 22. Further, the toner cartridges 430Y, 430M, 430C, and 430K are arranged and disposed in the Y direction. That is, the X direction in which the process cartridges PY, PM, PC, and PK are arranged, and the Y direction in which the toner cartridges 430Y, 430M, 430C, and 430K cross each other.

As shown in part (c) of FIG. 2, the toner cartridges 430Y, 430M, 430C, and 430K are supported detachably mountable to a cartridge holder 420 provided in the apparatus main assembly 72. In other words, the toner cartridges 430Y, 430M, 430C, and 430K are constituted so as to be mountable to the apparatus main assembly 72. For this reason, the toner cartridges 430Y, 430M, 430C, and 430K are capable of being exchanged without demounting the process cartridges PY, PM, PC, and PK from the apparatus main assembly 72. The toner cartridges 430Y, 430M, 430C, and 430K are disposed on the front surface side of the apparatus main assembly 72 and is exposed by opening the front door 72b, so that these toner cartridges can be easily exchanged.

The cartridge holder 420 is disposed downstream of the process cartridges PY, PM, PC, and PK on the front surface side of the apparatus main assembly 72 and in the X direction. For this reason, even in the case where the toner cartridges 430Y, 430M, 430C, and 430K are demounted from the cartridge holder 420, the process cartridges PY, PM, PC, and PK are covered with the cartridge holder 420 and are not exposed to an outside of the image forming apparatus 1 through the opening 72a. The toner cartridges 430Y, 430M, 430C, and 430K are accommodated in the apparatus main assembly 72 in a state in which the front door 72b is positioned in the closed position.

Further, as shown in part (a) of FIG. 2, a front surface 72c of the apparatus main assembly 72 is provided with indicators 208Y, 208M, 208C, and 208K. These indicators 208Y, 208M, 208C, and 208K indicate the colors of the toner accommodated in the toner cartridges 430Y, 430M, 430C, and 430K in an easy-to-understand manner for the user. The indicators 208Y, 208M, 208C, and 208K are constituted by LEDs, seals, or the like, and for example, the indicator 208Y is constituted by an LED which is lighted or blinked yellow or by a seal colored yellow. Further, each the indicators 208Y, 208M, 208C, and 208K may have a function of displaying a remaining amount of the toner accommodated in the associated one of the process cartridges PY, PM, PC, PK corresponding to the indicators 208Y, 208M, 208C, and 208K, respectively.

Incidentally, in this embodiment, the indicators 208Y, 208M, 208C, and 208K are provided on the front surface 72c of the apparatus main assembly 72 and is not covered with the front door 72b positioned in the closed position. That is, the indicators 208Y, 208M, 208C, and 208K are exposed to the outside of the image forming apparatus 1 irrespective of the position of the front door 72b. However, for example, the indicators 208Y, 208M, 208C, and 208K may also be disposed so as to be covered with the front door 72b positioned in the closed position and exposed to the outside by opening the front door 72b.

### [Image Forming Unit]

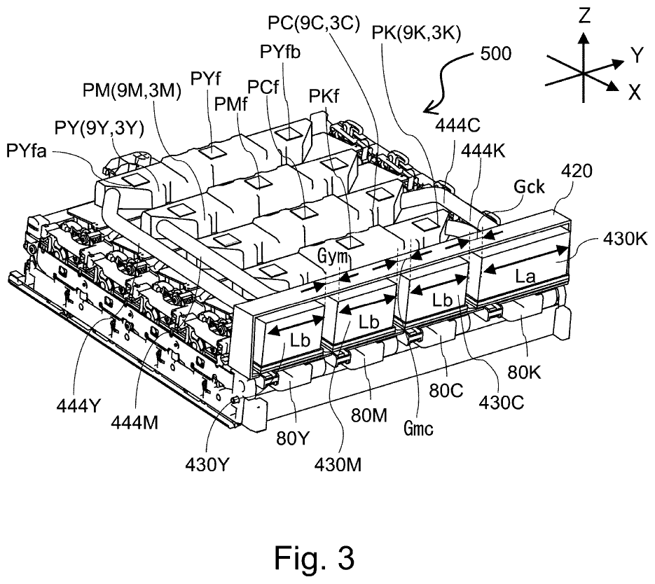

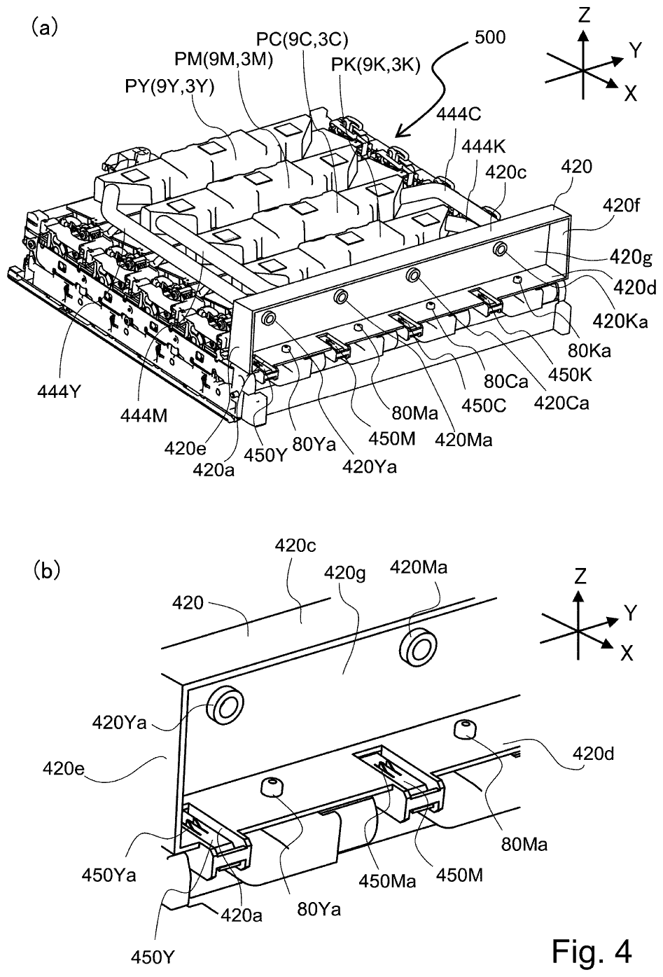

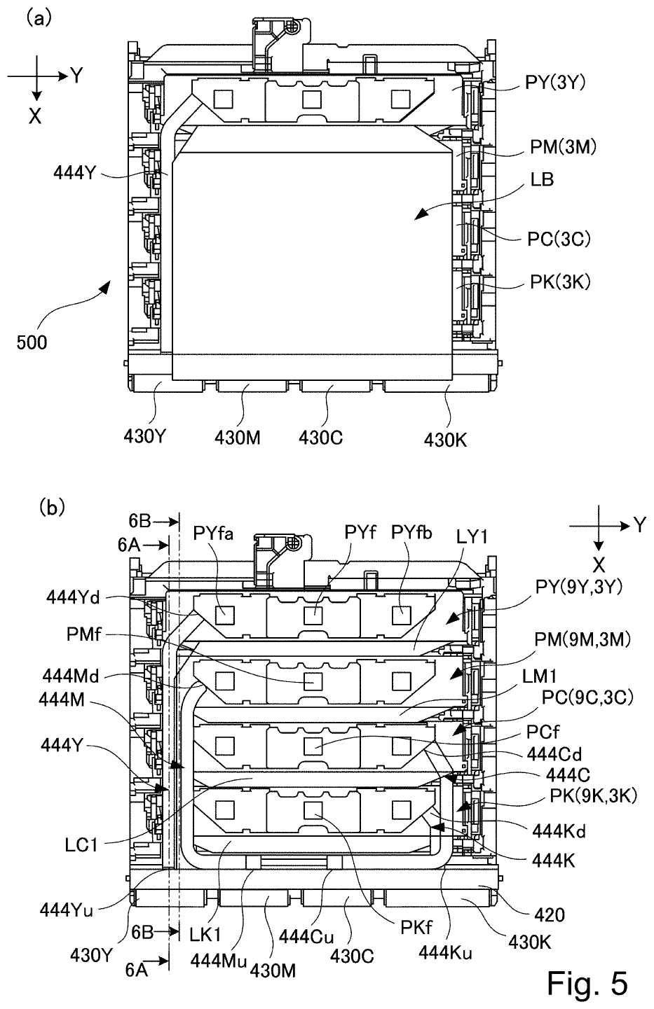

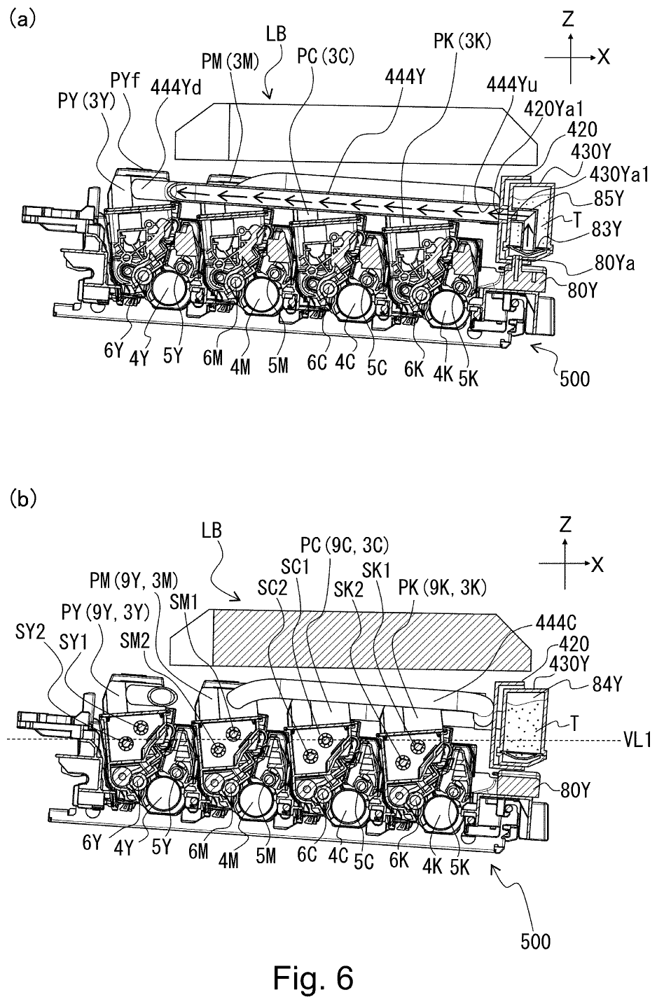

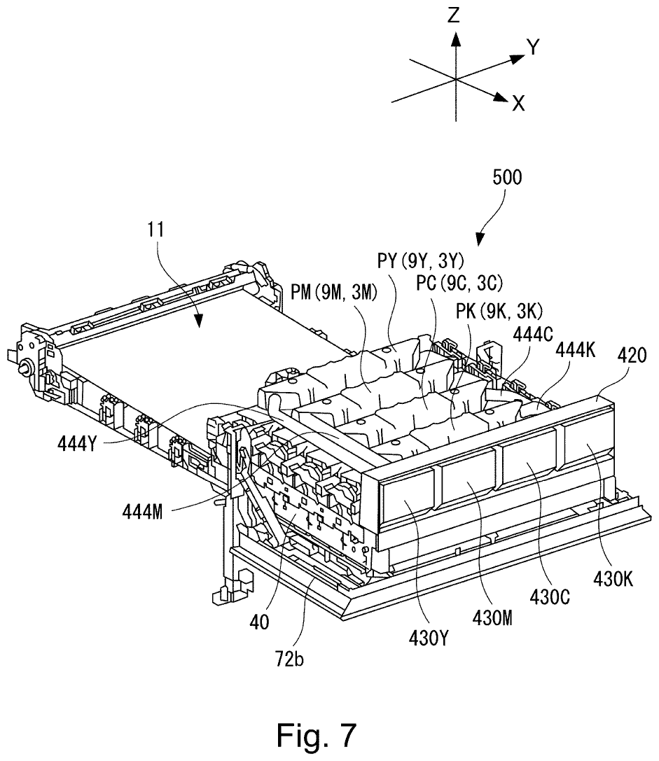

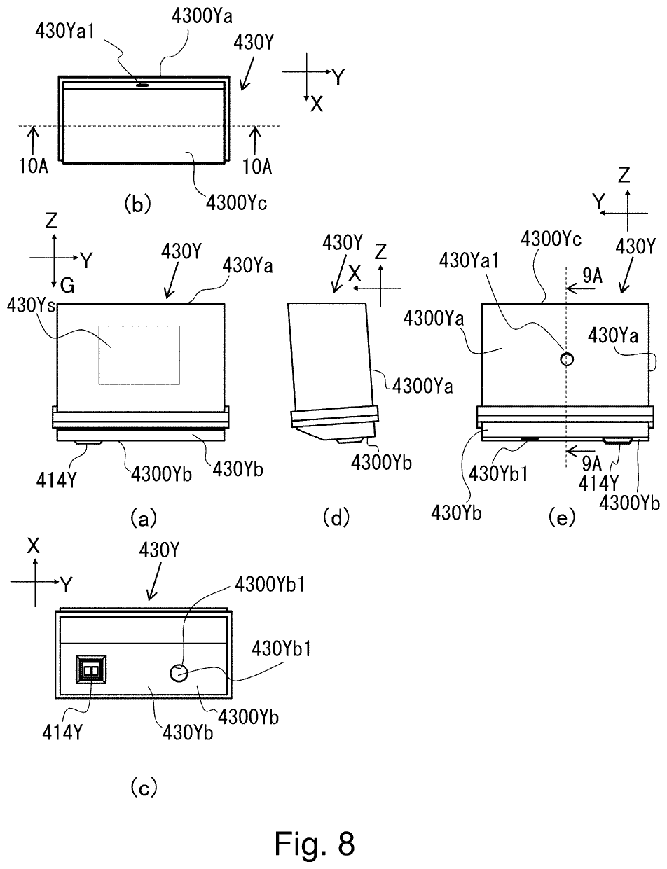

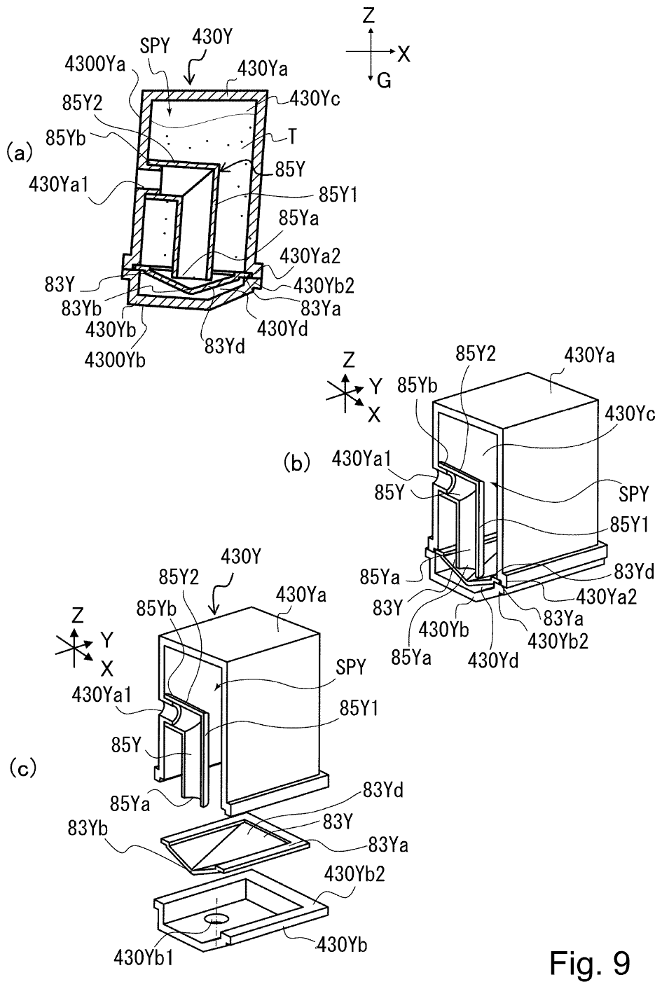

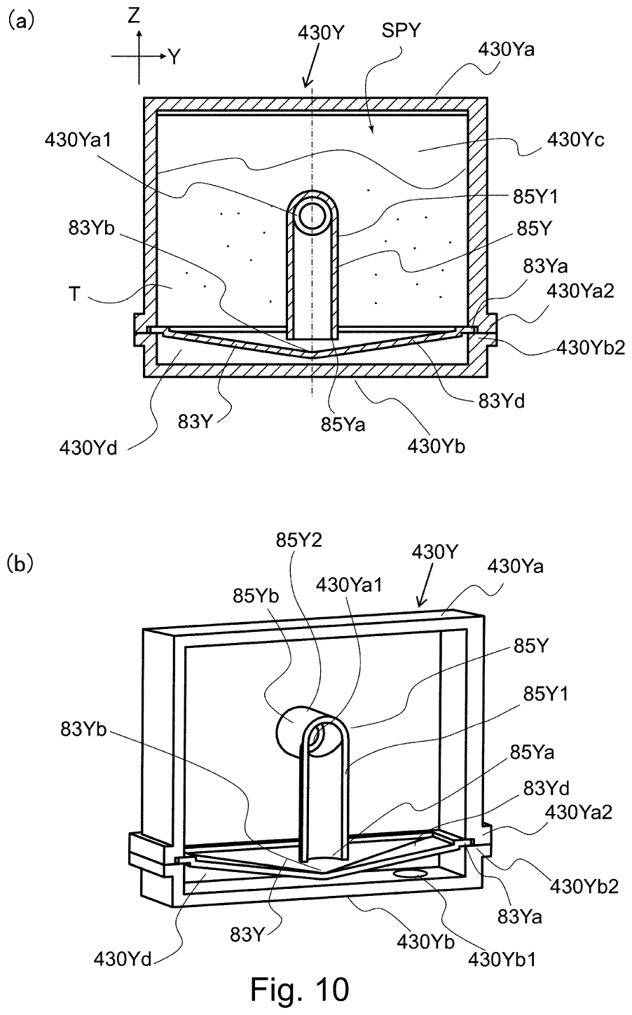

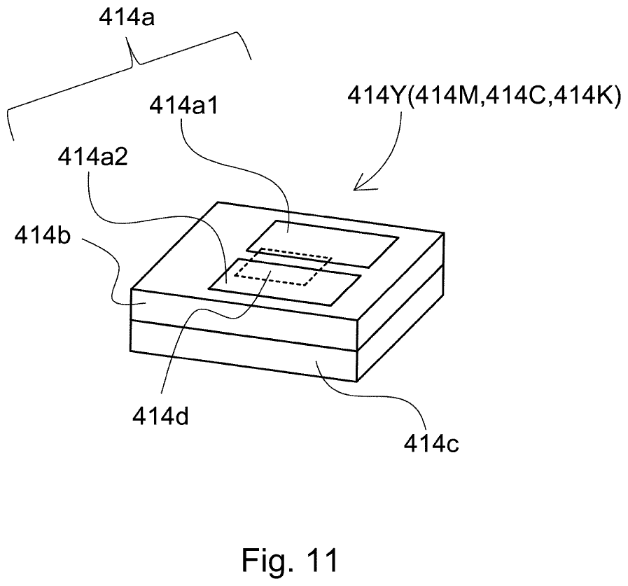

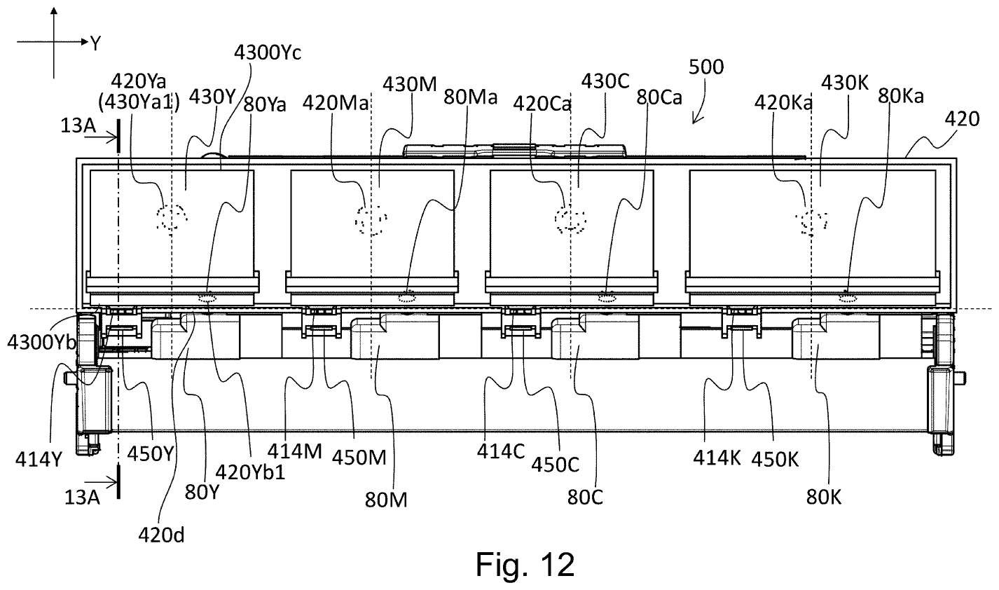

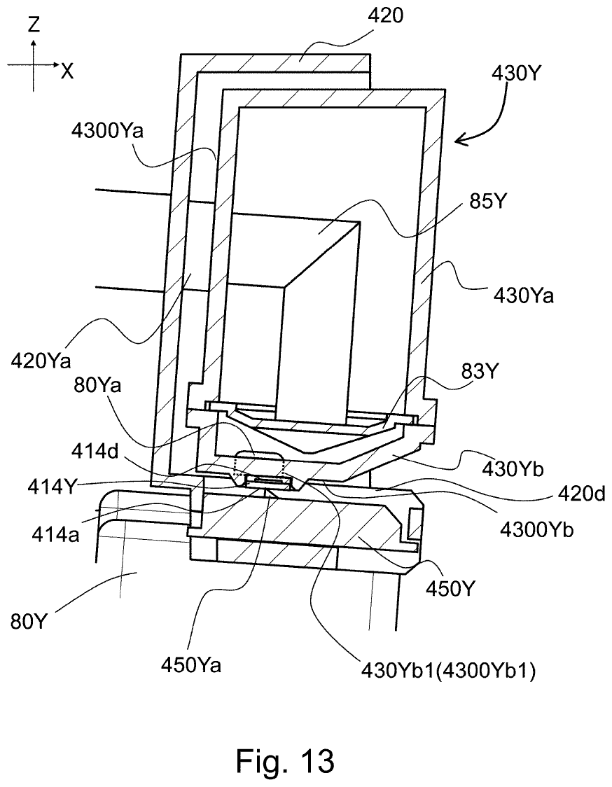

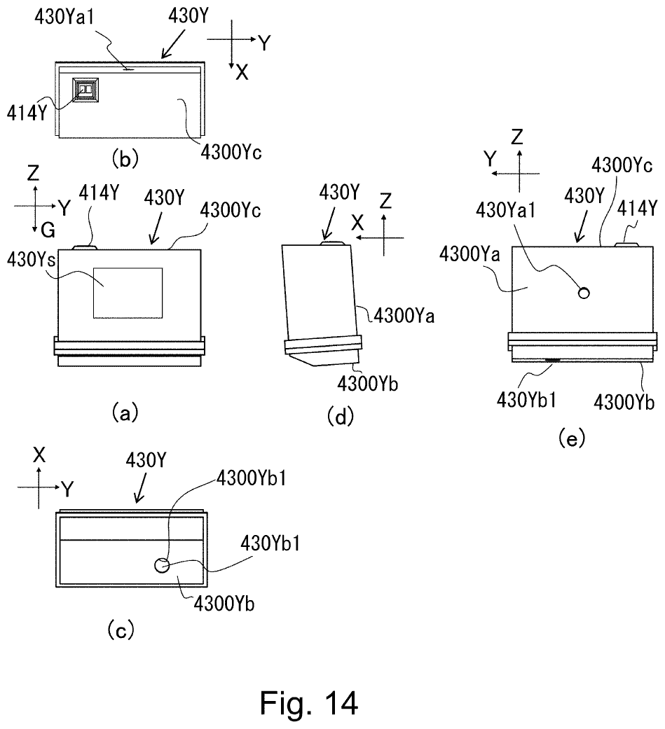

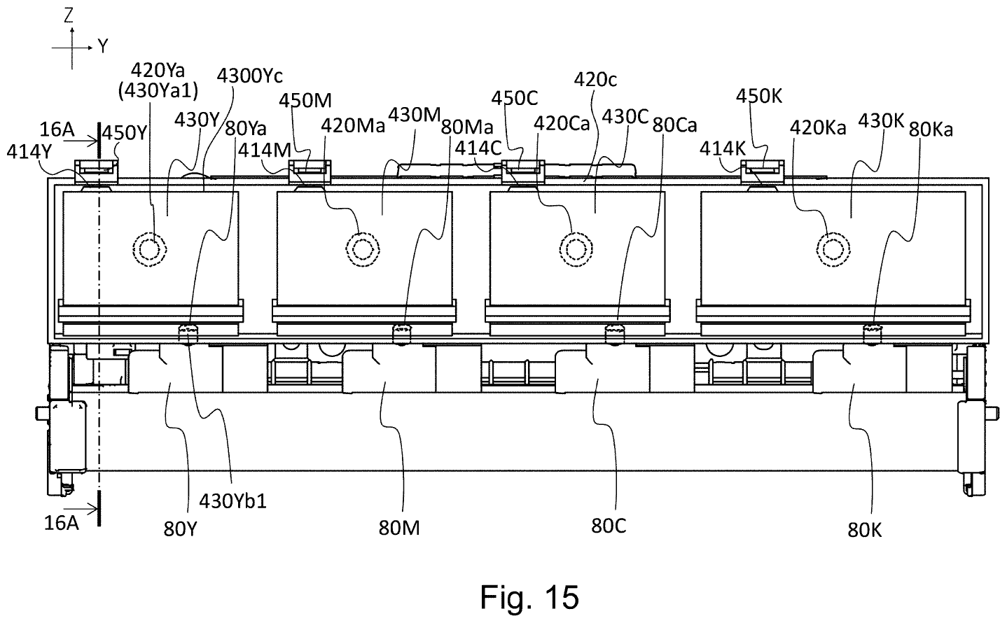

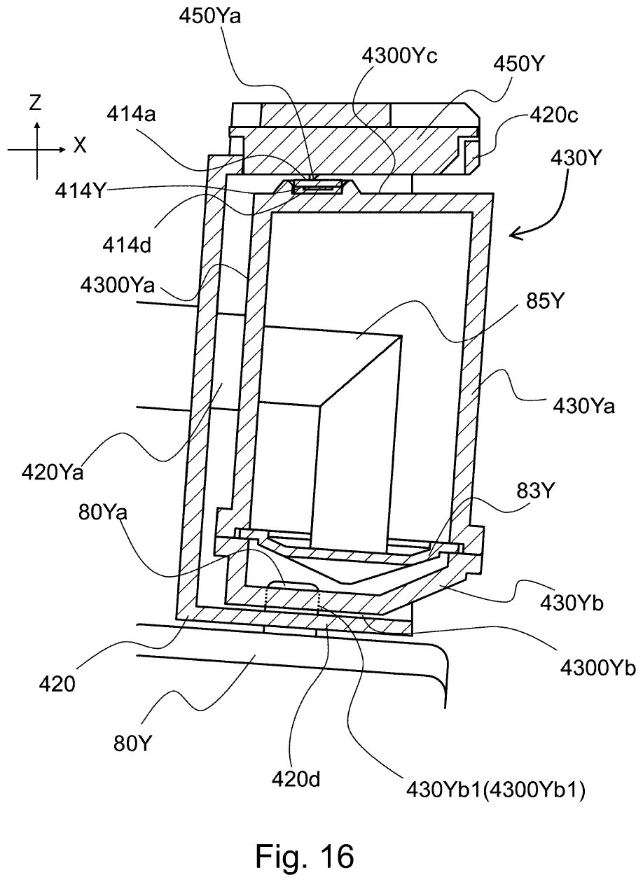

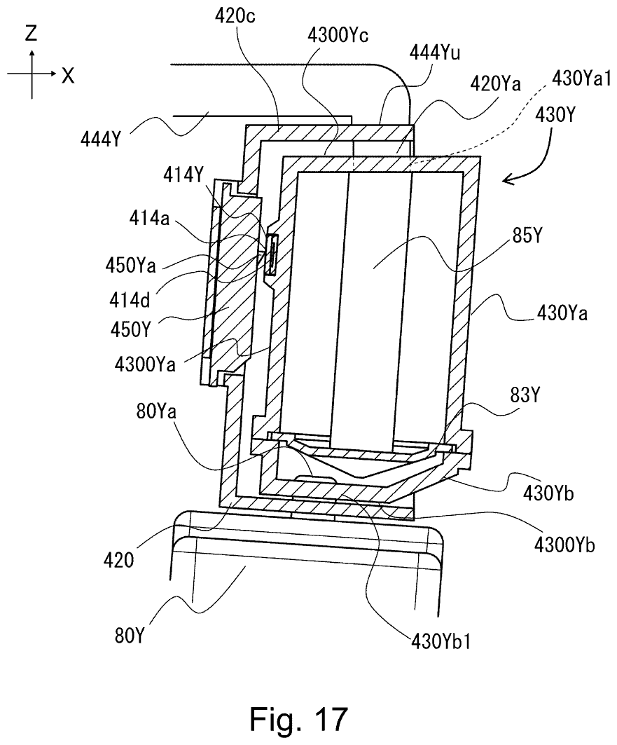

Next, by using FIGS. 3 to 7, an image forming unit 500 including a toner conveying mechanism for conveying the toner from the toner cartridges 430Y, 430M, 430C, and 430K to the process cartridges PY, PM, PC, and PK will be described. FIG. 3 is a perspective view showing the image forming unit 500. Part (a) of FIG. 4 is a perspective view showing the image forming unit 500 in a state in which the toner cartridges 430Y, 430M, 430C, and 430K are demounted. Part (b) of FIG. 4 is an enlarged perspective view showing the cartridge holder 420 in the state in which the toner cartridges 430Y, 430M, 430C, and 430K are demounted.

Part (a) of FIG. 5 is a plan view showing the laser scanner LB and the image forming unit 500, and part (b) of FIG. 5 is a plan view showing the image forming unit 500. Incidentally, in part (b) of FIG. 5, optical paths LY1, LM1, LC1, and LK1 are visualized and illustrated for convenience. Part (a) of FIG. 6 is a sectional view showing a 6A-6A cross section of part (b) of FIG. 5, and part (b) of FIG. 6 is a sectional view showing a 6B-6B cross section of part (b) of FIG. 5. FIG. 7 is a perspective view showing a state in which the image forming unit 500 is pulled out from the apparatus main assembly 72.

The image forming unit 500 includes the process cartridges PY, PM, PC, and PK, the toner cartridges 430Y, 430M, 430C, and 430K, the cartridge holder 420, and pump units 80Y, 80M, 80C, and 80K. The pump units 80Y, 80M, 80C, and 80K are disposed below the cartridge holder 420 and are arranged and disposed in the Y direction. Each of the pump units 80Y, 80M, 80C, and 80K is constituted by a capacity pump such as a reciprocating pump or a rotary pump, but is not limited thereto. For example, each of the pump units 80Y, 80M, 80C, and 80K may also be constituted by a non-capacity pump such as a centrifugal pump, a propeller pump, or a viscosity pump.

The reciprocating pump is a pump such that suction and discharge are performed by reciprocation of a piston, a plunger, or the like are includes a piston pump, a plunger pump, a diaphragm pump, or the like. The rotary pump is a pump such that suction and discharge are performed by causing a gear or a rotor to perform rotary motion and includes a gear pump, a screw pump, a vane pump, or the like. Incidentally, the four pump units 80Y, 80M, 80C, and 80K may also be constituted as a single pump unit or two or three pump units. Further, in this embodiment, the pump units 80Y, 80M, 80C, and 80K are provided to the apparatus main assembly 72, but may also be provided to the toner cartridges 430Y, 430M, 430C, and 430K, respectively.

The pump units 80Y, 80M, 80C, and 80K include, as shown in part (a) of FIG. 4, ejection ports 80Ya, 80Ma, 80Ca, and 80Ka, respectively, through which air is discharged, and these ejection ports 80Ya, 80Ma, 80Ca, and 80Ka open upward, i.e., in the Z direction.

The cartridge holder 420 is provided with openings corresponding to the ejection ports 80Ya, 80Ma, 80Ca, and 80Ka, and with inlets (intake openings) 420Ya, 420Ma, 420Ca, and 420Ka. The above-described openings are through holes provided on a lower surface of the cartridge holder 420, and the inlets 420Ya, 420Ma, 420Ca, and 420Ka are through holes provided on a rear surface of the cartridge holder 420. An opening direction of the inlets 420Ya, 420Ma, 420Ca, and 420Ka is the X direction, and therefore, crosses the Z direction which is an opening direction of the discharge openings 80Ya, 80Ma, 80Ca, and 80Ka.

In a state in which the toner cartridges 430Y, 430M, 430C, and 430K are mounted in the cartridge holder 420, the air discharged through the ejection ports 80Ya, 80Ma, 80Ca, 80Ka is supplied to an inside of the toner cartridges 430Y, 430M, 430C, and 430K. Then, the toner discharged together with the air from the toner cartridges 430Y, 430M, 430C, and 430K is received by supply pipe 444Y, 444M, 444C, and 444K through the inlets 420Ya, 420Ma, 420Ca, and 420Ka of the cartridge holder 420.

The supply pipes 444Y, 444M, 444C and 444K includes, as shown in part (b) of FIG. 5, upstream end portions 444Yu, 444Mu, 444Cu, and 444Ku, and downstream end portions 444 Yd, 444Md, 444Cd, and 444Kd connected to the developing containers 3Y, 3M, 3C, and 3K, respectively.

Further, the toner discharged together with the air from each of the toner cartridges 430Y, 430M, 430C, and 430K passes through each of the supply pipes 444Y, 444M, 444C, and 444K and is supplied to each of the developing containers 3Y, 3M, 3C, and 3K.

The downstream end portions 444 Yd and 444Md of the supply pipes 444Y and 444M are connected to upstream end portions, i.e., left end portions of the developing containers 3Y and 3M, respectively, in the Y direction. The downstream end portions 444Cd and 444Kd of the supply pipes 444C and 444K are connected to downstream end portions, i.e., right end portions of the developing containers 3C and 3K, respectively, in the Y direction. Thus, the supply pipes 444Y, 444M, 444C, and 444K are dividedly arranged on a left side and a right side, whereby lengths of the supply pipes 444Y, 444M, 444C, and 444K can be shortened. For this reason, pressure loss in the supply pipes 444Y, 444M, 444C, and 444K can be made small, and in addition, the image forming unit 500 can be downsized.

Next, arrangement of the toner cartridge 430Y will be described. As shown in part (b) of FIG. 6, the toner cartridge 430Y and the process cartridges PY, PM, PC, and PK are arranged so as to overlap with a virtual line VL extending in the X direction. That is, as shown in FIG. 2 and part (b), the toner cartridges 430Y, 430M, 430C, and 430K are arranged and disposed side by side with the process cartridges PY, PM, PC, and PK in the X direction. In other words, as viewed in the X direction, at least part of each of the toner cartridges 430Y, 430M, 430C, and 430K is disposed so as to overlap with the associated one of the process cartridges PY, PM, PC, and PK with respect to the Z direction. For this reason, the image forming unit 500 can be downsized with respect to the Z direction, i.e., the up-down direction, so that the image forming apparatus 1 can be downsized.

Incidentally, in this embodiment, the toner cartridges 430Y, 430M, 430C, and 430K are disposed as described above, but the present disclosure is not limited thereto. That is, the toner cartridges 430Y, 430M, 430C, and 430K may also disposed above the process cartridges PY, PM, PC, and PK in the Z direction.

Next, arrangement of the supply pipes 444Y, 444M, 444C, and 444K will be described.

The supply pipes 444Y, 444M, 444C, and 444K are disposed so as not to interface with optical paths LY1, LM1, LC1, and LK1 along which laser light LY, LM, LC, and LK emitted from the laser scanner LB passes as shown in part (b) of FIG. 5.

As described above, the supply pipes 444Y, 444M, 444C, and 444K are dividedly disposed on the left side and the right side. Further, the supply pipes 444Y, 444M, 444C, and 444K are, as shown in parts (a) and (b) of FIG. 5, disposed below the laser scanner LB.

As shown in part (a) of FIG. 5, at least a part of the supply pipe 444Y does not overlap with the laser scanner LB in plane view. An entire supply pipe 444M overlaps with the laser scanner LB in plane view. The supply pipe 444Y is disposed on a left side, i.e., a side upstream of the supply pipe 444M with respect to the Y direction. The supply pipes 444Y and 444M are, as shown in part (a) of FIG. 6, disposed on a side below the laser scanner LB and above the process cartridges PY, PM, PC, and PK. In other words, the supply pipes 444Y and 444M are disposed in a space between the laser scanner LB and the process cartridges PY, PM, PC, and PK with respect to the Z direction.

The optical paths LY1, LM1, LC1, and LK1 expands from above toward below in width with respect to a left-right direction, i.e., the Y direction. The supply pipe 444M is as shown in part (b) of FIG. 5 and part (b) of FIG. 6, disposed in a space between the laser scanner LB and the optical paths LM1, LC1, and LK1 with respect to the Z direction.

As shown in part (a) of FIG. 5, all the supply pipes 444C and 444K overlap with the laser scanner LB in plane view. The supply pipe 444C is disposed on a right side, i.e., a side downstream of the supply pipe 444K with respect to the Y direction. The supply pipes 444C and 444K are disposed on a side below the laser scanner LB and above the process cartridges PY, PM, PC, and PK. In other words, the supply pipes 444C and 444K are disposed in a space between the laser scanner LB and the process cartridges PY, PM, PC, and PK with respect to the Z direction. The supply pipe 444K is, as shown in parts (a) and (b) of FIG. 5 and part (b) of FIG. 6, disposed between the laser scanner LB and the optical path LK1 with respect to the Z direction.

The supply pipe 444C is, as shown in part (a) of FIG. 4, disposed above the supply pipe 444K. Further, a part of the supply pipe 444C overlaps with the supply pipe 444K with respect to the Y direction in the case where the supply pipe 444C is viewed in the Z direction. Further, a part of the supply pipe 444C overlaps with the supply pipe 444K with respect to the Z direction in the case where the supply pipe 444C is viewed in the Z direction.

As described above, the supply pipes 444Y, 444M, 444C, and 444K are compactly disposed so as not to interfere with the optical paths LY1, LM1, LC1, and LK1. By this, the image forming unit 500 and the image forming apparatus 1 can be downsized. Particularly, in the Y direction and the Z direction, the image forming unit 500 can be downsized. Incidentally, the supply pipes 444Y, 444M, 444C, and 444K are not required to be disposed in the above-described manner.

Further, the image forming unit 500 may preferably have a constitution in which the image forming unit 500 is easy to access the process cartridges PY, PM, PC, and PK and the supply pipes 444Y, 444M, 444C, and 444K in order to perform maintenance and exchange of the process cartridges PY, PM, PC, and PK and the supply pipes 444Y, 444M, and 444K, and the like. For this reason, in this embodiment, as shown in FIG. 7, the image forming unit 500 is constituted so s to be capable of being pulled out in the X direction relative to the apparatus main assembly 72 including the intermediary transfer belt unit 11. By this, it is possible to improve a maintenance property of the image forming unit 500. Incidentally, the image forming unit 500 may also be constituted so that the image forming unit 500 cannot be pulled out in the X direction relative to the apparatus main assembly 72.

### [Schematic Constitution of Toner Cartridge]

Next, by using FIG. 3 and part (b) of FIG. 8 to part (b) of FIG. 10, a schematic constitution of the toner cartridge 430Y as a cartridge will be described. Part (a) of FIG. 8 is a front view showing the toner cartridge 430Y, and part (b) of FIG. 8 is a plan view showing the toner cartridge 430Y. Part (c) of FIG. 8 is a bottom view showing the toner cartridge 430Y, part (d) of FIG. 8 is a side view showing the toner cartridge 430Y, and part (e) of FIG. 8 is a rear view showing the toner cartridge 430Y. Part (a) of FIG. 9 is a sectional view showing an 9A-9A cross section of part (e) of FIG. 8, part (b) of FIG. 9 is a perspective view showing a discharge pipe 85Y cut along XZ flat plane, and part (c) of FIG. 9 is an exploded perspective view of the toner cartridge 430Y shown in part (b) of FIG. 9. Part (a) of FIG. 10 is a sectional view showing a 10A-10A cross section of part (b) of FIG. 8, and part (b) of FIG. 10 is a perspective view showing the toner cartridge 430Y cut along YZ flat plane. As shown in FIG. 3, the toner cartridge 430Y has a width La in the Y

direction, and the width La is wider than a width LB of each of the toner cartridges 430Y, 430M, and 430C. Accordingly, a volume (capacity) for permitting accommodation of the toner by the toner cartridge 430K is larger than a volume of each of the toner cartridges 430Y, 430M, and 430C. In general, the black toner is larger in consumption amount than the toner of other colors, but as described above, the toner cartridge 430K is capable of accommodating the toner in amount larger than other toner cartridges 430Y, 430M, and 430C. For this reason, the number of times of exchange of the toner cartridges 430Y, 430M, 430C, and 430K can be equalized, so that usability can be improved.

Incidentally, in this embodiment, lengths of the toner cartridges 430Y, 430M, 430C, and 430K in the X direction are equal to each other. In addition, the lengths of the toner cartridges 430Y, 430M, 430C, and 430K in the X direction are less than the widths La and Lb thereof in the Y direction.

The toner cartridges 430Y, 430M, 430C, and 430K have similar constitutions except for the widths in the Y direction, and therefore, in the following, only the toner cartridge 430Y is described, and description of the toner cartridges 430M, 430C, and 430K will be omitted.

Further, in the following description, unless otherwise specified, while assuming that the toner cartridge 430Y takes an attitude described in the following, directions (X, Y, Z) will be defined as shown in part (a) of FIG. 8 to part (c) of FIG. 16. That is, description will be made on the assumption that the toner cartridge 430Y takes an attitude such that a toner accommodating chamber 430Yc, a filter 83Y, and an air chamber 430 Yd are arranged from above in a named order and that a short direction (X direction) and a longitudinal direction (Y direction) are parallel to a horizontal direction perpendicular to gravitational direction G. In this attitude, a direction opposite to the Z direction is the gravitational direction, and the toner cartridge 430Y is directed in a predetermined direction in which at least a part of the toner accommodating chamber 430Yc is positioned above the air chamber 430 Yd. The short direction of the toner cartridge 430Y at this time is defined as the Y direction, the longitudinal direction is defined as the Y direction, and a direction opposite to the gravitational direction G is defined as the Z direction. That is, the gravitational direction G is a direction in which a first frame 430Ya and a second frame 430Yb which are described later are arranged. Further, the Y direction is the longitudinal direction of the toner cartridge 430Y when the toner cartridge 430Y is viewed in the gravitational direction G. Further, the X direction is the short direction of the first frame 430Ya crossing both the Z direction and the Y direction.

A front-rear direction of the toner cartridge 430Y is represented by an X axis, and a direction from the rear surface toward the front surface is referred to as the X direction. The X direction is also referred to as a front direction or a front ward direction in some cases. Further, with respect to the X direction of the toner cartridge 430Y, a downstream side is referred to as a front surface side, and an upstream side is referred to as a rear surface side in some cases.

A left-right direction of the toner cartridge 430Y is represented by an Y axis, and a direction from left toward right of the toner cartridge 430Y is referred to as the Y direction. The Y direction is also referred to as a rear (ward) direction in some cases. Further, with respect to the Y direction of the toner cartridge 430Y, a downstream side is referred to as a right surface side, and an upstream side is referred to as a left surface side in some cases.

A up-down direction of the toner cartridge 430Y is represented by a X axis, and a direction from below toward above is referred to as the Z direction. The Z direction is also referred to as an upward direction, a height direction or a vertical direction in some cases. Further, with respect to the Z direction of the toner cartridge 430Y, a downstream side is referred to as an upper side, an upper surface side, or a top surface side, and an upstream side is referred to as a lower side, a lower surface side, or a bottom side in some cases.

The toner cartridge 430Y includes, as shown in part (a) of FIG. 8 to part (c) of FIG. 9, the first frame 430Ya as a first container, the second frame 430Yb as a second container, the filter 83Y, the discharge pipe 85Y, and a memory tag 414Y. In this embodiment, the first frame 430Ya and the second frame 430Yb are constituted by a resin material, but may also be constituted by paper or the like. Although described later specifically, the filter 83Y is held in a state in which the filter 83Y is sandwiched between the first frame 430Ya and the second frame 430Yb.

Further, an inside space SPY of the toner cartridge 430Y is, as shown in parts (b) and (c) of FIG. 9, partitioned into the toner accommodating chamber 430Yc and the air chamber 430 Yd by the filter 83Y. That is, the toner accommodating chamber 430Yc is constituted by the first frame 430Ya and the filter 83Y, and the air chamber 430 Yd is constituted by the second frame 430Yb and the filter 83Y. The air chamber 430 Yd as a second chamber is disposed under the filter 83Y, and the toner accommodating chamber 430Yc is disposed on the filter 83Y. That is, the air chamber 430 Yd is adjacent to the toner accommodating chamber 430Yc through the filter 83Y.

The toner accommodating chamber 430Yc as a first chamber is constituted so as to accommodate toner T (see part (a) of FIG. 9), and the toner T is in a state in which the toner T is supported in the gravitational direction by the filter 83Y in the toner accommodating chamber 430Yc. In the air chamber 430 Yd, the toner T is not accommodated. The filter 83Y is constituted, for example, a porous member comprising resin fibers. Pores of the filter 83Y have a size and a density such that passing of the air is permitted and that passing of the toner T is restricted. That is, the filter 83Y is constituted so that the passing of the air is permitted and so that the passing of the toner T is prevented.

As shown in part (e) of FIG. 8, a rear surface 4300Ya of the first frame 430Ya is provided with the discharge opening 430Ya1 through which the toner in the toner accommodating chamber 430Yc is discharged to an outside of the toner cartridge 430Y. The discharge opening 430Ya1 is constituted by a through hole penetrating through the first frame 430Ya in the X direction. Further, the rear surface 4300Ya is a side surface which is positioned between an upper surface 4300Yc and a lower surface 4300 Yd of the toner cartridge 430Y in the gravitational direction and which is directed in a direction crossing the gravitational direction.

As shown in parts (a), (c), and (e) of FIG. 8, the lower surface 4300Yb of the second frame 430Yb is provided with an inlet 430Yb1 constituted by a through hole penetrating through the second frame 430Yb in the Z direction, and with the memory tag 414Y. The discharge opening 430Ya1 and the inlet 430Yb1 communicate with the outside of the toner cartridge 430Y. The inlet 430Yb1 is formed by a portion-to-be-engaged 4300Yb1 provided to the lower surface 4300Yb.

These discharge opening 430Ya1 and inlet 430Yb1 may preferably be provided to a surface other than left and right side surfaces of side surfaces constituting the toner cartridge 430Y. In other words, the discharge opening 430Ya1 and the inlet 430Yb1 may preferably be provided to a side surface of the toner cartridge 430Y excluding a side surface directed in the Y direction which is a direction in which the toner cartridges 430Y, 430M, 430C, and 430K are arranged. By this, as shown in FIG. 3, gaps Gym, Gmc, and Gck, with respect to the Y direction, between the toner cartridges 430Y and 430M, between the toner cartridges 430m and 430c, and between the toner cartridges 430c and 430k, respectively, can be arranged. As a result, widths of the toner cartridges 430Y, 430M, 430C, and 430K with respect to the Y direction can be constituted so as to be wide, so that volumes of the toner capable of being accommodated in the toner cartridges 430Y, 430M, 430C, and 430K can be made large.

Incidentally, the gap Gym is a gap between the toner cartridge 430Y and the toner cartridge 430M, in the Y direction. The gap Gmc is a gap between the toner cartridge 430M and the toner cartridge 430C in the Y direction. The gap Gck is a gap between the toner cartridge 430K in the Y direction.

As shown in part (a) and (b) of FIG. 4, a cartridge holder 420 is provided with an ejection port 80Ya as an engaging portion engaging with the portion-to-be-engaged 4300Yb1 forming the inlet 430Yb1. The toner cartridge 430Y is positioned to the cartridge holder 420 by engagement of the portion-to-be-engaged 4300Yb1 with the ejection port 80Ya. By this, the inlet 430Yb1 of the toner cartridge 430Y and the ejection port 80Ya of the pump unit 80Y communicate with each other.

Further, the discharge opening 430Ya1 provided to the first frame 430Ya of the toner cartridge 430Y opens toward an upstream side in the X direction. That is, the discharge opening 430Ya1 opens in the same direction as a mounting direction of the toner cartridge 430Y to the cartridge holder 420. For this reason, when the toner cartridge 430Y is mounted, toward the upstream side in the X direction, to the cartridge holder 420, the discharge opening 430Y1 becomes easy to be engaged with the inlet 420Ya of the cartridge holder 420 so as to communicate with the inlet 420Ya.

Incidentally, arrangement of the discharge opening 430Ya1 is not limited to the above-described arrangement, and the discharge opening 430Ya1 may also be provided to the lower surface 4300Yb or the upper surface of the toner cartridge 430Y, and the inlet 430Yb1 may also be provided to the rear surface 4300Ya or the upper surface of the toner cartridge 430Y. Further, when there is a space margin of the apparatus main assembly 72, the discharge opening Ya1 and the inlet 430Yb1 may also be provided to the left and right surfaces of the respective side surfaces of the toner cartridge 430Y.

Further, the toner cartridge 430Y may be provided with an unshown sealing member for sealing the discharge opening 430Ya1. The sealing member is constituted by a seal or a shutter or the like. In a state in which the toner cartridge 430Y is mounted to the cartridge holder 420, the sealing member seals the discharge opening 430Ya1, so that it is possible to suppress that the toner in the toner accommodating chamber 430Yc leaks out to the outside of the toner cartridge 430Y. In the case where the sealing member is constituted by the seal, when the toner cartridge 430Y is mounted to the cartridge holder 420, the sealing member is removed from the rear surface 4300Ya of the toner cartridge 430Y. In the case where the sealing member is constituted by the shutter, when the toner cartridge 430Y is mounted to the cartridge holder 420, the sealing member is moved relative to the rear surface 4300Ya of the toner cartridge 430Y, and opens the discharge opening 430Ya1.

Further, as shown in part (a) of FIG. 8, a front surface 4304 of the toner cartridge 430Y is provided with a label 430Ys. The label 430Ys is for indicating a color of the toner accommodated in the toner cartridge 430Y. Incidentally, the label 430Ys is omitted from the drawings other than part (a) of FIG. 8. The label 430Ys may also be a label displaying a method for mounting the toner cartridge 430 to the cartridge holder 420 or information on the toner cartridge 430Y. For example, on the label 430Ys, a volume (capacity) of the toner capable of being accommodated in the toner cartridge 430Y, a use-by date, a storing method of the toner cartridge 430Y, a peeling method of the above-described sealing member, and the like may be indicated.

As shown in part (a) of FIG. 9 to part (b) of FIG. 10, the first frame 430Ya includes a first box portion forming the toner accommodating chamber 430Yc and a first flange portion 430Ya2 extending from a lower end portion of the first box portion toward the outside of the toner accommodating chamber 430Yc substantially in the horizontal direction. The first box portion is formed in a substantially rectangular parallelopiped shape. The first flange portion 430Ya2 is formed over a whole circumference of the lower end portion of the first box portion.

The second frame 430Yb is formed separately from the first frame 430Ya, and includes a second box portion forming the air chamber 430 Yd and a second flange portion 430Yb2 extending from an upper end portion of the second box portion toward the outside of the air chamber 430 Yd substantially in the horizontal direction. The second flange portion 430Yb2 is formed over a whole circumference of the upper end portion of the second box portion.

The filter 83Y is formed in a sheet shape. Further, the filter 83Y includes a bottom portion 83 Yd as a partitioning portion for permitting the inside the toner cartridge 430Y into the air chamber 430 Yd and the toner accommodating chamber 430Yc, and includes an outer edge portion 83Ya as a portion-to-be-nipped held by being nipped by the first flange portion 430Ya2 and the second flange portion 430Yb3. The outer edge portion 83Ya is provided so as to be continuous to the bottom portion 83 Yd. The bottom portion 83 Yd is formed more downward in the gravitational direction as the bottom portion 83 Yd is closer to a lowest portion 83Yb of the filter 83Y with respect to the X direction or the Y direction, and constitutes a bottom of the toner accommodating chamber 430Yc. In other words, in the case where the filter 83Y is viewed in the X direction, the bottom portion 83 Yd is inclined downward so as to be directed toward the lowest portion 83Yb in the gravitational direction G as the bottom portion 83 Yd is closer to the lowest portion 83Yb of the filter 83Y with respect to the Y direction. Similarly, in the case where the filter 83Y is viewed in the Y direction, the bottom portion 83 Yd is inclined downward so as to be directed toward the lowest portion 83Yb in the gravitational direction G as the bottom portion 83 Yd is closer to the lowest portion 83Yb of the filter 83Y with respect to the X direction. The lowest portion 83Yb is provided in a central portion with respect to the X direction and the Y direction.

Further, the first flange portion 430Ya2 and the second flange portion 430Yb2 are bonded together, so that the filter 83Y nipped between the first flange portion 430Ya2 and the second flange portion 430Yb2 is held. Incidentally, in the case where a holding force of the filter 83Y is insufficient, a whole circumference of the outer edge portion 83Ya of the filter 83Y may also be bonded to at least either one of the first flange portion 430Ya2 and the second flange portion 430Yb2. By this, the filter 83Y can be held with a high holding force.

Inside the toner accommodating chamber 430Yc, the discharge pipe 85Y is disposed. The discharge pipe 85Y includes an inlet 85Ya as a first pipe opening which opens downward in the gravitational direction G and an outlet 85Yb as a second pipe opening which opens rearward, i.e., toward an upstream side with respect to the X direction and which communicates with the discharge opening 430Ya1 of the toner cartridge 430 and then with an outside of the toner cartridge 430Y.

The outlet 85Yb is positioned above the inlet 85Ya. The discharge pipe 85Y includes a first pipe portion 85Y1 which is provided with the inlet 85Ya and which extends in the Z direction or the gravitational direction and a second pipe portion 85Y2 which is provided with the outlet 85Yb connected to the discharge opening 430Ya1 and which extends in the X direction, and is bent in a certain position. Thus, the discharge pipe 85Y as a pipe connects the inlet 85Ya and the outlet 85Yb. The inlet 85Ya is disposed so as to oppose the lowest portion 83Yb which is a part of the filter 83Y with a gap with respect to the gravitational direction G. Incidentally, an opposing region of the filter 83Y which opposes the inlet 85Ya in the gravitational direction G may also be provided as a part of the lowest portion 83Yb. The discharge pipe 85Y in this embodiment is constituted by a resin material, but may also be constituted by paper, a rubber, or the like.

### [Toner Conveying Mechanism]

Next, a mechanism for conveying the toner, accommodated in the toner accommodating chamber 430Yc of the toner cartridge 430Y, to the developing container 3Y of the process cartridge PY will be described. As shown in part (a) of FIG. 6, the air ejected upward through the ejection port 80Ya of the pump unit 80Y is taken into the air chamber 430 Yd through the inlet 430Yb1 (see part (b) of FIG. 10) of the toner cartridge 430Y. Then, this air is filled in the air chamber 430 Yd and passes through the filter 83Y, thus entering the toner accommodating chamber 430Yc.

The air entered the toner accommodating chamber 430Yc enters between particles of the toner T and fluidizes the toner T. An inside of the toner cartridge 430Y becomes positive pressure, so that the air passes through the discharge pipe 85Y and is liable to be discharged to the outside of the toner cartridge 430Y through the discharge opening 430Ya1. At this time, the toner T in the toner accommodating chamber 430Yc is moved together with the air in the discharge pipe 85Y and is discharged to the outside of the toner cartridge 430Y through the discharge opening 430Ya1. That is, the discharge pipe 85Y guides the toner in the toner accommodating chamber 430Yc, together with the air, from the inlet 85Ya to the discharge opening 430Ya1.

As in this embodiment, the air chamber 430 Yd which is a space high in hermetical sealability is provided between the ejection port 80Ya to the filter 83Y, the air ejected through the ejection port 80Ya is efficiently moved toward the filter 83Y without being dispersed to the outside of the toner cartridge 430Y. For example, there is a case where in a situation of agglomeration of the toner T in the toner accommodating chamber 430Yc such that the toner cartridge 430Y is subjected to vibration or is left standing for a long time, pressure needed to cause the air to flow into the toner accommodating chamber 430Yc through the filter 83 is high. Even in this case, the air is continuously sent from the pump unit 80Y to the air chamber 430 Yd, and thus pressure (air pressure) in the air chamber 430 Yd is made high, so that it becomes possible to send the air into the toner accommodating chamber 430Yc through the filter 83Y. Further, by providing the air chamber 430 Yd, the pump unit 80Y is sufficient when the pump unit 80Y has a performance capable of generating pressure at which the air can be continuously sent into the air chamber 430 Yd until the pressure becomes pressure needed for passing of the air into the toner accommodating chamber 430Yc through the filter 83Y. Therefore, particular requirements in ejection speed and ejection amount are not imposed on the pump unit 80Y, and thus, a small pump unit can also be employed and is capable of contributing to downsizing of the image forming apparatus.

The toner T discharged through the discharge opening 430Ya1 enters the upstream end portion 444Ya of the supply pipe 444 through the inlet 420Ya of the cartridge holder 420. Then, the toner T is conveyed to the inside of the supply pipe 444Y by the air lowing together with the toner T into the supply pipe 444Y, and then is supplied into the developing container 3Y of the process cartridge PY from the downstream end portion 444 Yd of the supply pipe 444. As shown in part (b) of FIG. 5, the downstream end portion 444 Yd of the supply pipe 444Y is connected to an upstream end portion of the developing container 3Y with respect to the Y direction, and therefore, the toner T is supplied to the upstream end portion of the developing container 3Y with respect to the Y direction.

Here, inside the developing container 3Y, as shown in part (b) of FIG. 6, stirring members SY1 and SY2 for stirring the toner in the developing container 3 are rotatably provided. Similarly, inside the developing containers 3M, 3C, and 3K, stirring members SM1 and SM2, stirring members SC1 and SC2, and stirring members SK1 and SK2 are provided, respectively.

The toner in the developing container 3Y is uniformized by rotating the stirring members SY1 and SY2, and is conveyed in the Y direction. Incidentally, in this embodiment, each of these stirring members is constituted by a rotation shaft and a sheet member fixed to the rotation shaft, but is not limited thereto. For example, each stirring member may also be constituted by a screw configured to convey the toner in the developing container along the Y direction. That is, a constitution in which the stirring members SY1, SY2, SM1, and SM3 are constituted by screws for conveying the toner toward a downstream side in the Y direction and in which the stirring members SC1, SC2, SK1, and SK2 are constituted by screws for conveying the toner toward an upstream side in the Y direction may also be employed.

Into the developing container 3Y, not only the toner but also the air flow, and therefore, inside pressure of the developing container 3Y increases. For this reason, in this embodiment, as shown in FIG. 3 are part (b) of FIG. 5, a through hole (not shown) is provided to an upper surface of the developing container 3Y, and this through hole is covered with an exhaust air filter PYf. The exhaust air filter PYf is constituted by non-woven fabric and is configured so that passing of the air is permitted and passing of the toner is restricted. By this, the toner flowed into the developing container 3Y is restricted by the exhaust air filter PYf from being discharged to the outside and remains in the developing container 3Y. On the other hand, at least a part of the air flowed into the developing container 3Y passes through the exhaust air filter PYf, and is discharged to the outside of the developing container 3Y. By this, rising of the inside pressure of the developing container 3Y is suppressed, so that the supply of the toner to the developing container 3Y can be smoothly performed.

Similarly, upper surfaces of the developing containers 3M, 3C, and 3K are provided with exhaust air filters PMf, PCf, and PKf and unshown through holes covered with these exhaust air filters PMf, PCf, and PKf, respectively.

The exhaust air filter PYf and the through hole are provided in a central portion of the developing container 3Y with respect to the Y direction. These exhaust air filter and through hole is not limited to a single combination, but may also be provided in a plurality of combinations for the developing container 3Y. For example, as shown in part (b) of FIG. 5, in addition to the exhaust air filter PYf, exhaust air filters PYfa and PYfb may be provided to the developing container 3Y. The exhaust air filters PYfa and PYfb cover unshown through holes provided to the developing container 3Y. With respect to the Y direction, the exhaust air filter PYfa is disposed upstream of the exhaust air filter PYf, and the exhaust air filter PYfb is disposed downstream of the exhaust air filter PYf. Thus, for one developing container, by providing the plurality of combinations of the exhaust air filters with the through holes, the raising of the inside pressure of the developing container can be efficiently suppressed. Further, positions of these exhaust air filters are not limited to the upper surface, but these exhaust air filters may also be provided to a side surface.

As described above, the toner accommodated in the toner cartridge 430Y is conveyed together with the air toward the developing container 3Y, and is supplied to the developing container 3Y. As in the case of the supply pipes 444Y, 444M, 444C and 444K in this embodiment, in the case of a constitution in which a direction of a conveying path is changed at a certain position or in the case of a constitution in which the conveying path is different depending on the color of the toner, it is preferable that the toner is conveyed using the air. By conveying the toner with use of the air, a design latitude of the toner conveying path is improved, and a member such as a screw for conveying the toner is not needed, and therefore, the number of component parts can be reduced, so that cost reduction can be realized.

Further, as described above, the inlet 85Ya as the first pipe opening of the discharge pipe 85Y is disposed opposed to the lowest portion 83Yb of the filter 83Y with a gap. The filter 83Y is held in an attitude such that the filter 83Y is inclined downward toward the lowest portion 83Yb, and therefore, in the case where a remaining amount of the toner in the toner accommodating chamber 430Yc becomes small, the toner fluidized by the air is moved along inclination of the filter 83Y and is collected in the lowest portion 83Yb. That is, the toner in the toner accommodating chamber 430Yc can be guided toward the inlet 85Ya of the discharge pipe 85Y.

For this reason, even in the case where the remaining amount of the toner in the toner accommodating chamber 430Yc becomes small, the toner collected in the lowest portion 83Yb can be efficiently discharged from the inlet 85Ya of the discharge pipe 85Y toward the outside of the toner cartridge 430Y through the discharge opening 430Ya1. Although the discharge opening 430Ya1 is disposed above the inlet 85Ya and the bottom portion 83 Yd of the filter 83Y, the toner is conveyed from the inlet 85Ya to the discharge opening 430Ya1 by the air. Therefore, an amount of the toner remaining in the toner accommodating chamber 430Yc without being supplied can be reduced.

### [Constitution of Memory Tag]

Next, by using FIG. 11, a constitution of the memory tag 414Y will be described. FIG. 11 is a perspective view showing the memory tag 414Y. The memory tag 414Y is provided to the toner cartridge 430Y as described above, but similarly, the toner cartridges 430M, 430C, and 430K are provided with memory tags 414M, 414C, and 414K, respectively, which have constitutions similar to the constitution of the memory tag 414Y.

As shown in FIG. 11, the memory tag 414Y as a memory in this embodiment is a plate-like member of 5.5 mm×5 mm in area and 1.4 mm in thickness, and is constituted by a substrate portion 414 and a protective portion 414c provided integrally with the substrate portion 44b. The substrate portion 414b includes a storing element 414d and an electroconductive portion 414a electrically connected to the storing element 414d. The storing element 414d stores information on the toner cartridge 430Y. The electroconductive portion 414a includes two memory contacts 414al and 414a2 (first contact and second contact), and can also be referred to as an electrode portion or an interface portion.

The protective portion 414c covers and protects the storing element 414d provided on the substrate portion 414b. In the storing element 414d, a lot number of the toner cartridge 430Y, an amount and characteristic information of the toner accommodated in the toner cartridge 430Y, characteristic information of the image forming apparatus 1 in which the toner cartridge 430Y is mounted, and the like are stored. The image forming apparatus 1 is electrically connected to the storing element 414d through the electroconductive portion 414a, so that the information of the storing element 414d is read and utilized for control of the image forming apparatus 1. In this embodiment, the electroconductive portion 414a is provided with the two memory contacts 414al and 414a2, but the number of memory contacts provided for the electroconductive portion 414a may also be one, or three or more.

### [Arrangement of Memory Tag]

Next, arrangement of the memory tag 414Y in the toner cartridge 430Y will be described. As shown in part (c) of FIG. 8, the memory tag 414Y is provided on a lower surface 4300Yb of the second frame 430Yb. The memory tag 414Y is fixed to the lower surface 4300Yb of the second frame 430Yb by a means such as an adhesive, a double-sided tape, thermal caulking, or the like. Incidentally, the lower surface 4300Yb of the second frame 430Yb is provided with snap fit, and to the snap fit, the memory tag 414Y may be detachably mounted.

A position of the memory tag 414Y is, as shown in parts (c) and (e) of FIG. 8, disposed with respect to the Y direction on a side opposite from a position of the inlet 430Yb1 relative to a position of the discharge opening 430Ya1.

In other words, the memory tag 414Y is, as shown in parts (c) and (e) of FIG. 8, disposed with respect to the Y direction on a side opposite from the inlet 430Yb1 relative to the central portion of the toner cartridge 430Y. In other words, the memory tag 414Y is, as shown in parts (c) and (e) of FIG. 8 and part (b) of FIG. 9, disposed with respect to the Y direction on a side opposite from the inlet 430Yb1 relative to the lowest portion 83Yb of the filter 83Y.

### [Memory Tag Connector]

Next, by using parts (a) and (b) of FIG. 4, FIG. 12, and FIG. 13, memory tag connectors 450Y, 450M, 450C and 450K provided to the apparatus main assembly 72 will be described. FIG. 12 is a front view showing the toner cartridges 430Y, 430M, 430C, and 430K mounted to the cartridge holder 420. FIG. 13 is a sectional view showing a 13A-13A cross section of FIG. 12.

As shown in parts (a) and (b) of FIG. 4, below the cartridge holder 420, the memory tag connectors 450Y, 450M, 450C, and 450K are provided. Incidentally, the memory tag connectors 450Y, 450M, 450C, and 450K may be held by the cartridge holder 420 or a member of the apparatus main assembly 72 other than the cartridge holder 420. The memory tag connectors 450Y, 450M, 450C, and 450K are disposed correspondingly to the associated memory tags of the toner cartridges 430Y, 430M, 430C, and 430K, respectively, and are arranged in the Y direction. Further, as shown in part (b) of FIG. 4, the memory tag connector 450Y is disposed upstream, with respect to the Y direction, of the ejection port 80Ya engaging with the corresponding toner cartridge 430Y.

The memory tag connector 450Y as a main assembly contact includes a connector electrode 450Ya, and the connector electrode 450Ya is electrically connected to a controller provided to the apparatus main assembly 72 through an unshown signal wire (line). Also, the memory tag connector 450M includes a connector electrode 450Ma, and similarly, the memory tag connectors 450C and 450K include connector electrodes.

As shown in FIG. 12 and FIG. 13, in a state in which the toner cartridge 430Y is mounted to the cartridge holder 420, the memory tag connector 450Y is disposed below the memory tag 414Y of the toner cartridge 430. Incidentally, as shown in part (b) of FIG. 4, the cartridge holder 420 is provided with a cut-away portion (opening) 420a into which the memory tag 414Y of the toner cartridge 430Y is capable of entering. The toner cartridge 430Y is positioned in a mounted state relative to the apparatus main assembly 72 and the cartridge holder 420 by engagement of the memory tag 414Y with the cut-away portion 420a and engagement of the portion-to-be-engaged 4300Yb1 with the ejection port 80Ya.

As shown in FIG. 12 and FIG. 13, in the state in which the toner cartridge 430Y is mounted to the cartridge holder 420, the electroconductive portion 414a of the memory tag 414Y and the connector electrode 450Ya of the memory tag connector 450Y are in contact with each other. That is, in a state in which the toner cartridge 430Y is mounted to the apparatus main assembly 72, the memory contacts 414al and 414a2 are configured to be pressed upward by the connector electrode 450Ya of the memory tag connector 450Y, and the portion-to-be-engaged 4300Yb1 is configured to engage with the ejection port 80Ya. By this, the memory tag 414Y and the controller of the apparatus main assembly 72 are electrically connected to each other, and the controller reads the information in the storing element of the memory tag 414Y and can utilize the information for control. Incidentally, this is also the same in a state in which the toner cartridges 430M, 430C, and 430K are mounted to the cartridge holder 420.

Here, as shown in parts (a) and (b) of FIG. 4, the cartridge holder 420 has a box shape such that a downstream side thereof with respect to the X direction is opened so as to be capable of receiving the toner cartridges 430Y, 430M, 430C, and 430K mounted and demounted along the X direction. In other words, the cartridge holder 420 includes a top surface 420c, a bottom 420d, a left side surface 420e, a right side surface 420f, and a rear surface 420g. The top surface 420c and the bottom 420d extend along the XY flat plane, and the bottom 420d is positioned below the top surface 420c. The left side surface 420e and the right side surface 420f extend along the XZ flat plane, and the right side surface 420f is disposed downstream of the left side surface 420e with respect to the Y direction. The rear surface 420g extends in the YZ flat plane, and the inlets 420Ya, 420Ma, 420Ca, and 420Ka are provided to the rear surface 420g.

As shown in FIG. 13, the memory tag 414Y of the toner cartridge 420Y and the inlet 430Yb1 are covered with the bottom 420d of the cartridge holder 420. For this reason, when the user demounts the toner cartridge 430Y from the cartridge holder 420 in the X direction, a possibility that the user touches the memory tag 414Y and the inlet 430Yb1 can be reduced. Therefore, it is possible to reduce electrical connection failure between the memory tag connector 450Y and the memory tag 414Y due to contamination of the memory tag 414Y. Further, it is possible to reduce that foreign matters are mixed into the air chamber 430 Yd through the inlet 430Yb1 and cause discharge failure of the toner.

Further, in this embodiment, the memory tags and the inlets of the toner cartridges, the memory tag connectors, and the ejection ports are arranged and disposed in the Y direction. For this reason, the toner cartridges 430Y, 430M, 430C, and 430K and the apparatus main assembly 72 can be downsized in the X direction. Incidentally, the memory tags and the inlets of the toner cartridges, the memory tag connectors, and the ejection ports re not necessarily required to be arranged in the Y direction.

Further, in this embodiment, as shown in FIG. 12, the memory tag 414Y is disposed on the lower surface 4300Yb of the toner cartridge 430Y. Further, the memory tag 414Y is positioned below the discharge opening 430Ya1 in the gravitational direction G, and is positioned upstream of the discharge opening 430Ya1 in the Y direction. In other words, as viewed in both the Y direction and the gravitational direction G, the memory tag 414Y is disposed in a position in which the memory tag 414Y does not overlap with the discharge opening 430Ya1.

For this reason, even in the case where the toner drops from the discharge opening 430Ya1 or the inlet 420Ya when the toner cartridge 430Y is mounted to and demounted from the cartridge holder 420, the dropped toner is not readily deposited on the memory tag 414Y. By this, the electrical connection failure between the memory tag connector 450Y and the memory tag 414Y can be reduced. Incidentally, the discharge opening 430Y1, the inlet 420Ya, and the memory tag 414Y are not necessarily required to be shifted and disposed in the Y direction.

As described above, according to this embodiment, it is possible to provide a new one form of an image forming apparatus in which the toner is conveyed by the air and a cartridge (toner cartridge) used in the image forming apparatus.

Incidentally, in this embodiment, the discharge opening 430Ya1 is provided to the rear surface 4300Ya of the toner cartridge 430Y, and the memory tag 414Y and the inlet 430Yb1 are provided to the lower surface 4300Yb, but the present disclosure is not limited thereto. For example, as shown in part (e) of FIG. 8 and FIG. 12, the discharge opening 430Ya1 may also be provided to the upper surface 4300Yc.

### Second Embodiment

Next, a second embodiment of the present disclosure will be described, but the second embodiment is such that the arrangement of the memory tags 414Y, 414M, 414C, and 414K in the first embodiment is changed. For this reason, constitutions similar to those in the first embodiment will be described by omitting illustration thereof or by adding the same reference numerals or symbols to the drawings relating to this embodiment.

Part (a) of FIG. 14 is a front view showing the toner cartridge 430Y according to the second embodiment, and part (b) of FIG. 14 is a plan view showing the toner cartridge 430Y. Part (c) of FIG. 14 is a bottom view showing the toner cartridge 430Y, part (d) of FIG. 14 is a side view showing the toner cartridge 430Y, and part (e) of FIG. 14 is a rear view showing the toner cartridge 430Y. FIG. 15 is a front view showing the toner cartridges 430Y, 430M, 430C, and 430K mounted to the cartridge holder 420. FIG. 16 is a sectional view showing a 16A-16A cross section of FIG. 15. Incidentally, in the following, the toner cartridge 430Y will be described, but the same applies to the toner cartridges 430M, 430C, and 430K.

In this embodiment, as shown in parts (a), (b), and (e) of FIG. 14 and FIG. 15, the memory tag 414Y is disposed on the upper surface 4300Yc of the toner cartridge 430Y. Further, as shown in FIG. 15, the memory tag connectors 450Y, 450M, 450C, and 450K are disposed correspondingly to the associated memory tags of the toner cartridges 430Y, 430M, 430C, and 430K, respectively, and are arranged in the Y direction. In a state in which the toner cartridge 430Y is mounted to the cartridge holder 420, the memory tag connector 450Y is disposed above the memory tag 414Y of the toner cartridge 430. Further, as shown in FIG. 16, the electroconductive portion 414a of the memory tag 414Y and the connector electrode 450Ya of the memory tag connector 450Y are in contact with each other. That is, in a state in which the toner cartridge 430Y is mounted to the apparatus main assembly 72, the memory contacts 414al and 414a2 of the electroconductive portion 414a are configured to be pressed downward by the connector electrode 450Ya of the memory tag connector 450Y, and the portion-to-be-engaged 4300Yb1 is configured to engage with the ejection port 80Ya. By this, the memory tag 414Y and the controller of the apparatus main assembly 72 are electrically connected to each other, and the controller reads the information in the storing element of the memory tag 414Y and can utilize the information for control. Further, the toner cartridge 430Y is urged downwardly by that the memory contacts 414al and 414a2 are pressed downward by the connector electrode 450Ya of the memory tag connector 450Y. By this, the toner cartridge 430Y is pressed in a direction in which an amount of engagement of the portion-to-be-engaged 4300Yb1 of the toner cartridge 430Y with the ejection port 80Ya is increased, so that the portion-to-be-engaged 4300Yb1 and the ejection port 80Ya can be reliably engaged with each other.

Further, the memory tag 414Y of the toner cartridge 420Y is covered with the top surface 420c of the cartridge holder 420. For this reason, when the user demounts the toner cartridge 430Y from the cartridge holder 420 in the X direction, a possibility that the user touches the memory tag 414Y and the inlet 430Yb1 can be reduced. Therefore, it is possible to reduce electrical connection failure between the memory tag connector 450Y and the memory tag 414Y due to contamination of the memory tag 414Y.

As described above, according to this embodiment, it is possible to provide a new one form of an image forming apparatus in which the toner is conveyed by the air and a cartridge (toner cartridge) used in the image forming apparatus.

### Third Embodiment

Next, a third embodiment of the present disclosure will be described, but the third embodiment is such that the arrangement of the memory tags 414Y, 414M, 414C, and 414K, each discharge opening (430Ya1), and each discharge pipe (85Y) in the first embodiment is changed. For this reason, constitutions similar to those in the first embodiment will be described by omitting illustration thereof or by adding the same reference numerals or symbols to the drawings relating to this embodiment.

FIG. 17 is a sectional view showing the toner cartridge 430Y and the memory tag 414Y according to the third embodiment. Incidentally, in the following, the toner cartridge 430Y will be described principally, but the same applies to the toner cartridge 430M, 430C, and 430K.

In this embodiment, as shown in FIG. 17, the discharge opening 430Ya1 of the toner cartridge 430Y is provided to the upper surface 4300Yc of the toner cartridge 430Y. Further, the inlet 420Ya of the cartridge holder 420 is provided to the top surface 420c of the cartridge holder 420 so as to oppose the discharge opening 430Ya1. Correspondingly thereto, the discharge pipe 85Y extends in the Z direction without being bent.

Further, the memory tag 414Y is disposed on the rear surface 4300Y of the toner cartridge 430Y. The rear surface 4300Ya is an end surface of the toner cartridge 430Y on a downstream side with respect to the mounting direction (−X direction) of the toner cartridge 430Y. Further, the memory tag connectors 450Y, 450M, 450C, and 450K are disposed correspondingly to positions of the memory tags of the toner cartridges 430Y, 430M, 430C, and 430K, respectively, and are arranged in the Y direction. In a state in which the toner cartridge 430Y is mounted to the cartridge holder 420, the memory tag connector 450Y is disposed upstream of the memory tag 414Y of the toner cartridge 430Y with respect to the X direction. Further, the electroconductive portion 414a of the memory tag 414Y and the connector electrode 450Ya of the memory tag connector 450 are in contact with each other. By this, the memory tag 414Y and the controller of the apparatus main assembly 72 are electrically connected with each other, so that the controller reads information in the storing element 414d of the memory tag 414Y and can utilize the information for control.

Further, the memory tag 414Y of the toner cartridge 430Y is covered with the top surface 420c of the cartridge holder 420. For this reason, when the user demount the toner cartridge 430Y from the cartridge holder 420 in the X direction, a possibility that the user touches the memory tag 414Y or the inlet 430Yb1 can be reduced. Therefore, electrical connection failure between the memory tag connector 450Y and the memory tag 414Y due to contamination of the memory tag 414Y can be reduced.

As described above, according to this embodiment, it is possible to provide a new one form of the image forming apparatus for conveying the toner by the air and the cartridge (toner cartridge) used in the image forming apparatus.

As described in the above-described embodiments, the memory tag 414Y may only be required to be disposed on the upper surface 4300Yc, the lower surface 4300 Yd, or the rear surface 4300Ya of the outer peripheral surface of the toner cartridge 430Y. By this, the memory tag 414Y is covered with the top surface 420c, the bottom 420d, or the rear surface 420g of the cartridge holder 420, so that the possibility that the user touches the memory tag 414Y can be reduced.

### Other Embodiments

Incidentally, in either of the above-described embodiments, the toner cartridge 430Y includes the first frame 430Ya and the second frame 430Yb, and the frame thereof is formed by the first frame 430Ya and the second frame 430Yb, but the present disclosure is not limited thereto.

For example, the toner cartridge 430Y may be constituted by one member or by three or more members.

Further, even in either of the above-described embodiments, the cartridge holder 420 included the top surface 420c, the bottom 420d, the left side surface 420e, the right side surface 420f, and the rear surface 420g, but the present disclosure is not limited thereto. For example, the cartridge holder 420 may also arbitrarily omit a surface other than the surface covering the memory tag 414Y of the mounted toner cartridge 430Y.

### SUMMARY OF PRESENT DISCLOSURE

The present disclosure includes at least the following contents.

### (Constitution 1)

A cartridge comprising:
a first chamber configured to accommodate toner and provided with a discharge opening for permitting discharge of the toner, accommodated in the first chamber, to an outside of the cartridge;
a filter configured to prevent passing of the toner and to permit passing of air;
a second chamber adjacent to the first chamber through the filter and provided with an inlet for taking in the air from the outside of the cartridge;
a pipe provided in the first chamber and configured to permit passing of the toner, wherein the pipe is provided with a first pipe opening which opposes a part of the filter and which opens toward the part and with a second pipe opening configured to communicate with the discharge opening, the pipe being extended from the first pipe opening to the second pipe opening; and
a memory configured to store information and including a memory contact,
wherein in a case where a direction in which the first chamber and the second chamber are arranged is a gravitational direction and the cartridge is directed in a predetermined direction in which at least a part of the first chamber is positioned above the second chamber, the memory is provided on an upper surface or a lower surface of the cartridge.

### (Constitution 2)

A cartridge according to the constitution 1, wherein in a case where the cartridge is directed in the predetermined direction, the inlet and the memory are provided on the lower surface.

### (Constitution 3)

A cartridge according to the constitution 1, wherein in a case where the cartridge is directed in the predetermined direction, the inlet is provided on the lower surface and the memory is provided on the upper surface.

### (Constitution 4)

A cartridge according to the constitution 3, wherein the cartridge is mountable to a main assembly, of an image forming apparatus, including an engaging portion and a main assembly contact,
wherein on the lower surface of the cartridge, a portion-to-be-engaged forming the inlet and engageable with the engaging portion is provided, and
wherein in a state in which the cartridge is mounted to the main assembly, the memory contact is configured to be pressed downward by the main assembly contact, and the portion-to-be-engaged is configured to be engaged with the engaging portion.

### (Constitution 5)

A cartridge according to any one of the constitutions 1 to 4, wherein in a case where the cartridge is directed in the predetermined direction, the discharge opening is positioned between the upper surface and the lower surface with respect to the gravitational direction and is provided on a side surface of the cartridge directed in a direction crossing the gravitational direction.

### (Constitution 6)

A cartridge according to any one of the constitutions 1 to 5, wherein in a case where the cartridge is directed in the predetermined direction, as viewed in a direction perpendicular both to a longitudinal direction of the cartridge as viewed in the gravitational direction and to the gravitational direction, the memory is disposed in a non-overlapping position with the discharge opening.

### (Constitution 7)

A cartridge according to any one of the constitutions 1 to 6, wherein in a case where the cartridge is directed in the predetermined direction, with respect to the longitudinal direction of the cartridge as viewed in the gravitational direction, a position of the memory is on a side opposite from a position of the inlet relative to a position of the discharge opening.

### (Constitution 8)

A cartridge according to any one of the constitutions 1 to 7, further comprising:
a first container configured to form the first chamber in cooperation with the filter; and
a second container configured to form the second chamber in cooperation with the filter,
wherein the first container and the second container are bonded to each other in a state in which the filter is sandwiched therebetween.

### (Constitution 9)

A cartridge mountable to a main assembly of an image forming apparatus with respect to a mounting direction, the cartridge comprising:
a first chamber configured to accommodate toner and provided with a discharge opening for permitting discharge of the toner, accommodated in the first chamber, to an outside of the cartridge;
a filter configured to prevent passing of the toner and to permit passing of air;
a second chamber adjacent to the first chamber through the filter and provided with an inlet for taking in the air from the outside of the cartridge;
a pipe provided in the first chamber and configured to permit passing of the toner, wherein the pipe is provided with a first pipe opening which opposes a part of the filter and which opens toward the part and with a second pipe opening configured to communicate with the discharge opening, the pipe being extended from the first pipe opening to the second pipe opening; and
a memory configured to store information,
wherein the memory is provided on an end surface of the cartridge on a downstream side with respect to the mounting direction.

### (Constitution 10)

A cartridge according to the constitution 9, wherein in a case where a direction in which the first chamber and the second chamber are arranged is a gravitational direction and the cartridge is directed in a predetermined direction in which at least a part of the first chamber is positioned above the second chamber, the end surface on which the memory is provided is a surface positioned between an upper surface and a lower surface of the cartridge.

### (Constitution 11)

A cartridge according to the constitution 10, wherein the inlet is disposed on the lower surface of the cartridge.

### (Constitution 12)

A cartridge according to the constitution 11, wherein the discharge opening is disposed on the upper surface of the cartridge.

### (Constitution 13)

A cartridge according to any one of the constitutions 9 to 12, further comprising:
a first container configured to form a first chamber in cooperation with the filter; and
a second container configured to form a second chamber in cooperation with the filter,
wherein the first container and the second container are bonded to each other in a state in which the filter is sandwiched therebetween.

According to the present disclosure, it is possible to provide one form of the cartridge accommodating the toner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-143445, filed on Aug. 23, 2024, which is hereby incorporated by reference herein in its entirety.

What is claimed is:

1. A cartridge comprising:
a first chamber configured to accommodate toner and provided with a discharge opening for permitting discharge of the toner, accommodated in the first chamber, to an outside of the cartridge;
a filter configured to prevent passing of the toner and to permit passing of air;
a second chamber adjacent to the first chamber through the filter and provided with an inlet for taking in the air from the outside of the cartridge;
a pipe provided in the first chamber and configured to permit passing of the toner, wherein the pipe is provided with a first pipe opening which opposes a part of the filter and which opens toward the part and with a second pipe opening configured to communicate with the discharge opening, the pipe being extended from the first pipe opening to the second pipe opening; and
a memory configured to store information and including a memory contact,
wherein in a case where a direction in which the first chamber and the second chamber are arranged is a gravitational direction and the cartridge is directed in a predetermined direction in which at least a part of the first chamber is positioned above the second chamber, the memory is provided on an upper surface or a lower surface of the cartridge.

2. The cartridge according to claim 1, wherein in a case where the cartridge is directed in the predetermined direction, the inlet and the memory are provided on the lower surface.

3. The cartridge according to claim 1, wherein in a case where the cartridge is directed in the predetermined direction, the inlet is provided on the lower surface and the memory is provided on the upper surface.

4. The cartridge according to claim 3, wherein the cartridge is mountable to a main assembly, of an image forming apparatus, including an engaging portion and a main assembly contact,
wherein on the lower surface of the cartridge, a portion-to-be-engaged forming the inlet and engageable with the engaging portion is provided, and
wherein in a state in which the cartridge is mounted to the main assembly, the memory contact is configured to be pressed downward by the main assembly contact, and the portion-to-be-engaged is configured to be engaged with the engaging portion.

5. The cartridge according to claim 1, wherein in a case where the cartridge is directed in the predetermined direction, the discharge opening is positioned between the upper surface and the lower surface with respect to the gravitational direction and is provided on a side surface of the cartridge directed in a direction crossing the gravitational direction.

6. The cartridge according to claim 1, wherein in a case where the cartridge is directed in the predetermined direction, as viewed in a direction perpendicular both to a longitudinal direction of the cartridge as viewed in the gravitational direction and to the gravitational direction, the memory is disposed in a non-overlapping position with the discharge opening.

7. The cartridge according to claim 1, wherein in a case where the cartridge is directed in the predetermined direction, with respect to a longitudinal direction of the cartridge as viewed in the gravitational direction, a position of the memory is on a side opposite from a position of the inlet relative to a position of the discharge opening.

8. The cartridge according to claim 1, further comprising:
a first container configured to form the first chamber in cooperation with the filter; and
a second container configured to form the second chamber in cooperation with the filter,
wherein the first container and the second container are bonded to each other in a state in which the filter is sandwiched therebetween.

9. A cartridge mountable to a main assembly of an image forming apparatus with respect to a mounting direction, the cartridge comprising:
a first chamber configured to accommodate toner and provided with a discharge opening for permitting discharge of the toner, accommodated in the first chamber, to an outside of the cartridge;
a filter configured to prevent passing of the toner and to permit passing of air;
a second chamber adjacent to the first chamber through the filter and provided with an inlet for taking in the air from the outside of the cartridge;
a pipe provided in the first chamber and configured to permit passing of the toner, wherein the pipe is provided with a first pipe opening which opposes a part of the filter and which opens toward the part and with a second pipe opening configured to communicate with the discharge opening, the pipe being extended from the first pipe opening to the second pipe opening; and
a memory configured to store information,
wherein the memory is provided on an end surface of the cartridge on a downstream side with respect to the mounting direction.

10. The cartridge according to claim 9, wherein in a case where a direction in which the first chamber and the second chamber are arranged is a gravitational direction and the cartridge is directed in a predetermined direction in which at least a part of the first chamber is positioned above the second chamber, the end surface on which the memory is provided is a surface positioned between an upper surface and a lower surface of the cartridge.

11. The cartridge according to claim 10, wherein the inlet is disposed on the lower surface of the cartridge.

12. The cartridge according to claim 11, wherein the discharge opening is disposed on the upper surface of the cartridge.

13. The cartridge according to claim 9, further comprising:
a first container configured to form a first chamber in cooperation with the filter; and
a second container configured to form a second chamber in cooperation with the filter,
wherein the first container and the second container are bonded to each other in a state in which the filter is sandwiched therebetween.
